(19) United States
(12) Patent Application Publication
(10) Pub. No.: US 2009/0103015 A1
(43) Pub. Date: Apr. 23, 2009

(54) Polarizing Plate and Liquid Crystal Display Device

(75) Inventor: Eiichiro Aminaka, Kanagawa (JP)

Correspondence Address: BUCHANAN, INGERSOLL & ROONEY PC, POST OFFICE BOX 1404, ALEXANDRIA, VA, 22313-1404, US

(73) Assignee: FIJIFILM Corporation, Minato-ku (JP)

(21) Appl. No.: 11/992,519

(22) PCT Filed: Sep. 26, 2006
(86) PCT No.: PCT/JP2006/319639

§ 371 Date: Mar. 25, 2008

(30) Foreign Application Priority Data
Sep. 26, 2005 (JP) 2005-277602

(51) Int. Cl. G02F 1/1335; G02B 1/08

(52) U.S. Cl. 349/96; 428/1.31

(57) ABSTRACT

A polarizing plate comprising at least one protective film; and a polarizing film, wherein the protective film disposed on a liquid crystal cell side has Re_{(λ)} and Rth_{(λ)} satisfying the conditions of 45 nm≦Re₍₅₉₀₎≦65 nm and 150 nm≦Rth₍₅₉₀₎≦240 nm, and the polarizing plate gives, when disposed in an orthogonal position, a hue a^{*} and a hue b^{*} of the polarizing plate disposed in an orthogonal position satisfying the formulae −1.0≦a^{*}≦2.0 and −1.0≦b^{*}≦2.0 (wherein Re_{(λ)} represents a retardation value in plane at a wavelength of λnm (unit: nm), and Rth_{(λ)} represents a retardation value along a thickness of the film (unit: nm)).

### TECHNICAL FIELD

The present invention relates to a polarizing plate which reduces color shift upon black display of a liquid crystal display device in the case of changing the viewing angle, and a liquid crystal display device using the polarizing plate.

### BACKGROUND ART

Liquid crystal display devices are widely used as monitors for personal computers or mobile devices and for TV sets due to their various advantages of being operable at a low voltage, consuming little power and permitting to reduce the thickness. As such liquid crystal display devices, there have been proposed liquid crystal display devices of various modes different from each other in the state of alignment of liquid crystal molecules within the liquid crystal cell. TN mode has so far been the main mode wherein molecules are aligned in a state of being twisted about 90° from the lower substrate of the liquid crystal cell toward the upper substrate.

A liquid crystal display device is generally constituted by a liquid crystal cell, an optical compensatory sheet and a polarizer. The optical compensatory sheet is used for removing coloration of an image or for enlarging the viewing angle and, as the sheet, a stretched birefringence film or a film comprising a transparent film having coated thereon a liquid crystal is used.

For example, Japanese Patent No. 2,587,398 discloses the technique of applying to a TN mode liquid crystal cell an optical compensatory sheet prepared by coating a discotic liquid crystal on a triacetyl cellulose film, aligning the liquid crystal and fixing the alignment, to thereby enlarge the viewing angle. With liquid crystal display devices for TV set use which are of a large size and expected to be viewed at various angles requirement for viewing angle dependence is so severe that even the above-mentioned technique fails to satisfy the severe requirement. Thus, there have been studied liquid crystal display devices different from the TN mode liquid crystal display devices, such as IPS (In-Plane Switching) mode, OCB (Optically Compensatory Bend) mode or VA (Vertically Aligned) mode ones. In particular, the VA mode liquid crystal display device gives a high contrast and can be produced in a high yield, thus being noted as liquid crystal display devices for TV set use.

Now, a cellulose acylate film has a special feature that, in comparison with other polymer films, it has a high optical isotropy (low retardation value). Therefore, it usually finds application to uses which require optical isotropy, such as a polarizing plate.

On the other hand, an optical compensatory sheet (retardation film) for a liquid crystal display device is required to have an optical anisotropy (high retardation value). In particular, an optical compensatory sheet for VA mode is required to have a retardation in plane (Re) of from 30 to 200 nm and a retardation along the thickness (Rth) of from 70 to 400 nm. Thus, it has been common to use, as the optical compensatory sheet, a synthetic polymer film having a high retardation value such as a polycarbonate film or a polysulfone film. As is described above, in the field of optical materials, it has been a general principal to use a synthetic polymer film in the case where an optical anisotropy (high retardation value) is required for a polymer film and to use a cellulose acylate film in the case where an optical isotropy (low retardation value) is required.

Reversing this conventional general principle, JP-A-2001-249223 proposes a cellulose acetate film having an enough high retardation value to find application to the use which requires the optical anisotropy. In this proposal, in order to realize a high retardation value with cellulose triacetate, an aromatic compound having at least 2 aromatic rings, in particular, a compound having 1,3,5-triazine rings, is added thereto, followed by stretching treatment. It is generally known that cellulose triacetate is a high molecular material which is so difficult to stretch that it is difficult to increase its birefringence index. In the proposal, however, birefringence index is increased by aligning the additive simultaneously upon the stretching treatment, thus realizing a high retardation value. This film has the advantage that, since it can also function as the protective film of the polarizing plate, it can provide an inexpensive, thin liquid crystal display device.

### DISCLOSURE OF THE INVENTION

JP-A-2001-249223 discloses that a wide viewing angle can be obtained by using an optical compensatory sheet consisting of a cellulose acetate film having an Re value in the range of from 20 nm to 70 nm and an Rth value in the range of from 70 nm to 400 nm, but does not disclose techniques for reducing difference in tint (color shift) between viewing from the normal direction of a liquid cell and viewing from other inclined direction upon black display.

In recent years, with respect to liquid crystal display devices, there has been an increasing demand for improving displayed color as well as the viewing angle defined in terms of contrast ratio

An object of the invention is to provide a polarizing plate which provides a wide viewing angle and causes a reduced color shift upon black display, and a liquid crystal display device using the polarizing plate which device provides a wide viewing angle and causes a reduced color shift upon black display.

It has conventionally been studied to obtain a wide viewing angle and reduce color shift upon black display at the same time by controlling the Re value and the Rth value of a protective film of a polarizing plate provided on a liquid crystal cell side. However, sufficient improvement for reducing color shift has not been attained only by controlling the two parameters.

As a result of intensive investigations, the inventors have unexpectedly found that a liquid crystal display device which provides a wide viewing angle and reduces color shift upon black display can be provided by not only controlling the Re value and the Rth value of a protective film of a polarizing plate on a liquid crystal cell side to be within optimal ranges but also controlling hues of polarizers to be within optimal ranges when the polarizers are disposed in an orthogonal position and controlling the color temperature of a back light of a liquid crystal display device to be within an optimal range. That is, the invention relates to a polarizing plate and a liquid crystal display device having the following constitution, whereby the above objects of the invention have been attained.

(1) A polarizing plate comprising:

at least one protective film; and

a polarizing film,

wherein the protective film disposed on a liquid crystal cell side has Re_{(λ)} and Rth_{(λ)} satisfying following numerical formulae (I) and (II), and

wherein the polarizing plate gives, when disposed in an orthogonal position, a hue a^{*} and a hue b^{*} of the polarizing plate disposed in an orthogonal position satisfying following numerical formulae (III) and (IV):

45 nm≦Re₍₅₉₀₎≦65 nm numerical formula (I)

150 nm≦Rth₍₅₉₀₎≦240 nm numerical formula (II)

−1.0≦a^{*}≦2.0 numerical formula (III)

−1.0≦b^{*}≦2.0 numerical formula (IV)

wherein Re_{(λ)} represents a retardation value in plane at a wavelength of λnm (unit: nm); and

Rth_{(λ)} represents a retardation value along a thickness of the film (unit: nm).

(2) The polarizing plate as described in (1) above, which has a single plate transmission of 41% or more, a parallel transmission of 35% or more, an orthogonal transmission of 0.02% or less and a polarizing degree of 99.93% or more.

(3) The polarizing plate as described in (1) or (2) above,

wherein the protective film disposed on a liquid crystal cell side has Re_{(λ)} and Rth_{(λ)} satisfying following numerical formulae (V) to (VIII):

1.0≦Re₍₄₈₀₎/Re₍₅₅₀₎≦1.1 numerical formula (V)

0.9≦Re₍₆₃₀₎/Re₍₅₅₀₎≦1.0 numerical formula (VI)

1.0≦Rth₍₄₈₀₎/Rth₍₅₅₀₎≦1.1 numerical formula (VII)

0.9≦Rth₍₆₃₀₎/Rth₍₅₅₀₎≦1.0. numerical formula (VIII)

(4) The polarizing plate as described in any of (1) to (3) above,

wherein the protective film disposed on a liquid crystal side is a cellulose acylate film comprising a cellulose acylate obtained by substituting hydroxyl groups of glucose unit constituting cellulose with an acyl group containing 2 or more carbon atoms, and satisfying following formulae (IX) and (X):

2.0≦DS2+DS3+DS6≦3.0 (IX)

DS6/(DS2+DS3+DS6)≧0.315 (X)

wherein DS2 represents a substitution degree of hydroxyl group at 2-position of the glucose unit by the acyl group;

DS3 represents a substitution degree of hydroxyl group at 3-position of the glucose unit by the acyl group; and

DS6 represents a substitution degree of hydroxyl group at 6-position of the glucose unit by the acyl group.

(5) The polarizing plate as described in (4) above,

wherein the acyl group is an acetyl group.

(6) The polarizing plate as described in any of (1) to (3) above,

wherein the protective film disposed on a liquid crystal side is a cellulose acylate film containing a cellulose acylate, which is a mixed fatty acid ester of cellulose, as a major polymer component, wherein hydroxyl groups of the cellulose are substituted by an acetyl group and an acyl group containing 3 or more carbon atoms, and

wherein a substitution degree A of the acetyl group and a substitution degree B of the acyl group containing 3 or more carbon atoms satisfying following numerical formulae (XI) and (XII):

2.0≦A+B≦3.0 numerical formula (XI)

0<B. numerical formula (XII)

(7) The polarizing plate as described in (6) above,

wherein the acyl group containing 3 or more carbon atoms is a butanoyl group.

(8) The polarizing plate as described in (6) above,

wherein the acyl group containing 3 or more carbon atoms is a propionyl group.

(9) The polarizing plate as described in any of (6) to (8) above,

wherein the substitution degree of the hydroxyl group at 6-position of cellulose is 0.75 or more.

(10) The polarizing plate as described in any of (1) to (3) above,

wherein the protective film disposed on a liquid crystal side is a film comprising a cyclic polyolefin.

(11) The polarizing plate as described in any of (1) to (10) above,

wherein the protective film disposed on a liquid crystal side contains at least one of a plasticizer, a UV ray absorbent, a peeling accelerator, a dye and a matt agent.

(12) The polarizing plate as described in any of (1) to (11) above,

wherein the protective film disposed on a liquid crystal side contain one or more rod-like or discotic compound as a retardation increasing agent.

(13) The polarizing plate as described in any of (1) to (12) above,

wherein the protective film disposed on a liquid crystal side is a film consisting of a single layer.

(14) A liquid crystal display device comprising:

a liquid crystal cell; and

a pair of polarizing plates respectively disposed on both sides of the liquid crystal cell in an orthogonal position,

wherein at least one of the pair of the polarizing plates is a polarizing plate as described in any of (1) to (13) above.

(15) The liquid crystal display device as described in (14) above,

wherein a color temperature of a back light is between 8,000 and 10,000K.

(16) The liquid crystal display device as described in (14) or (15) above, wherein the liquid crystal cell is of a vertically aligned mode.

### BRIEF DESCRIPTION OF THE DRAWING

FIG. 1 is a schematic view showing a method of sticking a cellulose acylate film upon preparation of the polarizing plate of the invention;

FIG. 2 is a cross-sectional view schematically showing the cross-sectional structure of the polarizing plate of the invention; and

FIG. 3 is a cross-sectional view schematically showing the cross-sectional structure of the polarizing plate of the invention.

### BEST MODE FOR CARRYING OUT THE INVENTION

The invention will be described in detail below. Additionally, in the case where a numerical value represents a physical value or a characteristic value, a description of “(numerical value 1) to (numerical value 2)” used in the invention means “(numerical value 1) to (numerical value 2) inclusive”. Also, in this specification, a description of “(meth)acryloyl” means “at least either of acryloyl and methacryloyl”. The same applies to “(meth)acrylate” and “(meth)acrylic acid”.

The inventors of the invention have found that the above-described problems can be solved by controlling the Re value and the Rth value of a protective film disposed on the liquid crystal cell side and controlling the hues of polarizing plates to be in the following ranges when the plates are disposed in an orthogonal position.

That is, the invention is characterized in that Re_{(λ)} and Rth_{(λ)} of a protective film to be disposed on the liquid crystal side satisfy the following numerical formulae (I) and (II), and the hue a and the hue b of a polarizing plate satisfy the following numerical formulae (III) and (IV):

45 nm≦Re₍₅₉₀₎≦65 nm numerical formula (I)

150 nm≦Rth₍₅₉₀₎≦240 nm numerical formula (II)

−1.0≦a^{*}≦2.0 numerical formula (III)

−1.0≦b^{*}≦2.0 numerical formula (IV)

wherein Re_{(λ)} represents a retardation value in plane at a wavelength of λnm (unit: nm), and Rth_{(λ)} represents a retardation value along the thickness of the film (unit: nm).

As a result of intensive investigations, the inventors have found the following facts, thus having achieved the invention based on the findings.

(1) When Re₍₅₉₀₎ and Rth₍₅₉₀₎ are outside the above-described ranges specified by the numerical formulae (I) and (II), there results a seriously reduced viewing angle.
(2) In the case where Re(590)<45 nm and/or Rth(590)<150 nm, tint viewed from an inclined angle with respect to the normal direction of a liquid crystal cell is strongly reddish upon black display. In the case where Re₍₅₉₀₎>65 nm and/or Rth₍₅₉₀₎>240 nm, tint viewed from an inclined angle with respect to the normal direction of a liquid crystal cell is strongly bluish upon black display.
(3) Regarding the numerical formula (III), when a^{*}<−1.0, the polarizer gives an increased greenish hue whereas, when a^{*}>2.0, it gives an increased reddish hue. Regarding the numerical formula (IV), when b^{*}<−1.0, the polarizer gives an increased bluish hue whereas, when b^{*}>2.0, it gives an increased yellowish hue.

The single plate transmission and the parallel transmission of a polarizing plate are characteristics which influences luminance upon white display. Further investigation of the inventors of the invention has revealed that, in order to realize a high luminance, the single plate transmission is preferably 41% or more, more preferably 42% or more, and the parallel transmission is preferably 35% or more, more preferably 36% or more.

Also, the orthogonal transmission of a polarizing plate is a characteristic which influences luminance upon black display and, in order to realize a good black display or a high contrast, the orthogonal transmission is preferably 0.02% or less, more preferably 0.01% or less.

Wavelength distribution of Re_{(λ)} and Rth_{(λ)} of a protective film to be disposed on a liquid crystal cell side is a characteristic which influences the tint when viewed from an inclined direction with respect to the normal direction of a liquid crystal cell upon black display, and it has been found that it is preferred for the characteristic to satisfy the following formulae (V) to (VIII):

1.0≦Re₍₄₈₀₎/Re₍₅₅₀₎≦1.1 numerical formula (V)

0.9≦Re₍₆₃₀₎/Re₍₅₅₀₎≦1.0 numerical formula (VI)

1.0≦Rth₍₄₈₀₎/Rth₍₅₅₀₎≦1.1 numerical formula (VII)

0.9≦Rth₍₆₃₀₎/Rth₍₅₅₀₎≦1.0. numerical formula (VIII)

The Re value and the Rth value of the protective film can be controlled by adjusting the substitution degree of cellulose acylate to be used for the protective film, the kind and the amount of a retardation increasing agent to be added to the cellulose acylate film, the drying temperature and the drying time for the cellulose acylate film, the stretch ratio and the stretching temperature for the cellulose acylate film, and the amount of a residual solvent upon stretching. Preferred ranges and preferred controlling methods for individual factors will be described below.

First, a cellulose acylate capable of exhibiting a large optical anisotropy to be used in the invention will be described in detail below. In the invention, different two or more kinds of cellulose acylates may be mixed to use. In the case where the cellulose acylate film is a protective film to be disposed on the liquid crystal cell side of a polarizing plate, it preferably satisfies the following formulae (IX) and (X):

2.0≦DS2+DS3+DS6≦3.0 (IX)

DS6/(DS2+DS3+DS6)≧0.315 (X)

(wherein DS2 represents a substitution degree of hydroxyl group at 2-position of the glucose unit by the acyl group, DS3 represents a substitution degree of hydroxyl group at 3-position of the glucose unit by the acyl group, and DS6 represents a substitution degree of hydroxyl group at 6-position of the glucose unit by the acyl group).

To satisfy the above-described formulae (IX) and (X) can improve solubility in a solvent and reduce humidity dependence of optical anisotropy.

Although a smaller sum of DS2+DS3+DS6 provides a larger optical anisotropy, there results a large change in optical anisotropy when humidity changes, thus a too small sum being practically problematical. On the other hand, a larger sum of DS2+DS3+DS6 provides a smaller optical anisotropy, though humidity dependence of optical anisotropy is reduced. Thus, in order to obtain both a sufficient emergence of optical anisotropy and a sufficient humidity dependence of optical anisotropy, the sum of DS2+DS3+DS6 is preferably from 2.2 to 2.9, more preferably from 2.4 to 2.85.

In order to suppress change in optical anisotropy by change in humidity without spoiling emergence of optical anisotropy, it is preferred to further adjust DS6/(DS2+DS3+DS6) to 0.315 or more, with 0.318 or more being more preferred.

The aforesaid specific cellulose acylate may be a cellulose acylate which is a mixed fatty acid ester of cellulose, wherein hydroxyl groups of cellulose are substituted by an acetyl group and an acyl group containing 3 or more carbon atoms, with a substitution degree A of the acetyl group and a substitution degree B of the acyl group containing 3 or more carbon atoms satisfying the following numerical formulae (XIII) and (XIIV):

2.0≦A+B≦3.0 numerical formula (XII)

0<B. numerical formula (XIIV)

Glucose units connected to each other through β-1,4 bond to constitute cellulose have free hydroxyl groups at 2-, 3- and 6-positions. Cellulose acylate is a polymer obtained by esterifying part or whole of these hydroxyl groups with an acyl group. The acyl substitution degree means the proportion of esterified hydroxyl group of cellulose at the 2-, 3- or 6-position (substitution degree for 100% esterification being 1).

In the invention, the sum (A+B) of the substitution degree A and the substitution degree B of hydroxyl groups is preferably from 2.0 to 3.0 as shown by the above numerical formula (XII) more preferably from 2.2 to 2.9, particularly preferably from 2.40 to 2.85. Also, the substitution degree B is preferably more than 0 as shown by the above numerical formula (XIIV), more preferably 0.6 or more.

In case where (A+B) is less than 2.0, there results such a strong hydrophilicity that it is susceptible to the influence of surrounding humidity. Further, with B, it is preferred that 28% or more of B corresponds to the substituent for the 6-position hydroxyl group, with the proportion being more preferably 30% or more, still more preferably 31% or more, particularly preferably 32% or more.

Still further, the sum of the substitution degrees A and B at 6-position of cellulose is preferably 0.75 or more, more preferably 0.80 or more, particularly preferably 0.85 or more. A solution for preparing a film having a favorable solubility and a favorable filterable property can be prepared from such cellulose acylate, which permits to prepare a good solution using a chlorine-free organic solvent. Further, it becomes possible to prepare a solution having a low viscosity and a good filterable property.

The acyl group (B) containing 3 or more carbon atoms is not particularly limited and may be an aliphatic group or an aromatic hydrocarbon group. Examples of cellulose acylate having the acyl group. (B) include alkylcarbonyl esters, alkenylcarbonyl esters, aromatic carbonyl esters and aromatic alkylcarbonyl esters of cellulose, which may further have a substituent. Preferred examples of the acyl group B include a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an iso-butanoyl group, a t-butanoyl group, a cyclohexanecarbonyl group, an oleoyl group, a benzoyl group, a naphthylcarbonyl group and a cinnamoyl group. Of these, propionyl, butanoyl, dodecanoyl, octadetanoyl, t-butanoyl, oleoyl, benzoyl, naphthylcarbonyl and cinnamoyl are preferred. Particularly preferred are a propionyl group and a butanoyl group. With a propionyl group, the substitution degree B is preferably 1.3 or more.

As the mixed fatty acid cellulose acylate, there are specifically illustrated cellulose acetate propionate and cellulose acetate butyrate.

### [Process for Synthesizing Cellulose Acylate]

The fundamental principle of a process for synthesizing cellulose acylate is described in Migita et al., Mokuzai Kagaku, pp. 180-190 (Kyoritsu Shuppan, 1968). A typical synthesizing process is a liquid phase acetylating process using a carboxylic acid anhydride-acetic acid-sulfuric acid catalyst.

In obtaining the cellulose acylate, a cellulose raw material such as cotton fiber linter or wood pulp is pretreated with a suitable amount of acetic acid, then added to a previously cooled mixed solution for carboxylation to conduct esterification, thus a complete cellulose acylate (wherein the sum of acyl substitution degrees at 2-, 3- and 6-positions is approximately 3.00) being synthesized.

The mixed solution for carboxylation generally includes acetic acid as a solvent, a carboxylic acid anhydride as an esterifying agent, and sulfuric acid as a catalyst. The carboxylic acid anhydride is commonly used in a stoichiometrically excess amount based on the sum of the amount of cellulose and the amount of moisture existing within the system, which react with the carboxylic acid anhydride. After completion of the esterification reaction, an aqueous solution of a neutralizing agent (e.g., carbonate, acetate or oxide of calcium, magnesium, iron, aluminum or zinc) is added thereto in order to hydrolyze the excess carboxylic acid anhydride remaining within the system and neutralize part of the esterification catalyst.

Next, the thus-obtained complete cellulose acylate is kept at 50 to 90° C. in the presence of a small amount of an acetylation reaction catalyst (generally, remaining sulfuric acid) to saponify and ripen in order to change the acyl substitution degree and the polymerization degree of the cellulose acylate to desired levels. At the point where a desired cellulose acylate is obtained, the catalyst remaining within the system is completely neutralized with the neutralizing agent such as is described hereinbefore or, without neutralization, the cellulose acylate solution is thrown into water or dilute sulfuric acid (or water or dilute sulfuric acid is thrown into the cellulose acylate solution) to separate cellulose acylate, followed by washing and conducting a stabilizing treatment, thus the specific cellulose acylate being obtained.

With the aforesaid cellulose acylate film, the polymer component constituting the film preferably comprises substantially the specific cellulose acylate.

The term “substantially” as used herein means 55% by mass or more (preferably 70% by mass or more, more preferably 80% by mass or more) of the polymer component based on the total cellulose acylate amount. (In this specification, mass ratio is equal to weight ratio.)

The cellulose acylate is preferably used in a particulate form. 90% by mass or more of the particles to be used preferably have a particle size of from 0.5 to 5 mm. Also, 50% by mass or more of the particles to be used preferably have a particle size of from 1 to 4 mm. The cellulose acylate particles preferably have a shape as spherical as possible.

The polymerization degree of cellulose acylate to be preferably used in the invention is preferably from 200 to 700, more preferably from 250 to 550, still more preferably from 250 to 400, particularly preferably from 250 to 350, in terms of viscosity-average polymerization degree. The average polymerization degree can be measured by the limiting viscosity method of Uda et al. (Kazuo Uda & Hideo Saito; Sen'i Gakkaishi, vol. 18, No. 1, pp. 105-120, 1962). Further, detailed descriptions are given in JP-A-9-95538.

Removal of a low molecular component increases the average molecular mass (polymerization degree), but lowers the viscosity in comparison with common cellulose acylate. Therefore, as the aforesaid cellulose acylate, those from which a low molelculer component has been removed are useful.

Such celluloce acylate containing a less amount of the low molecular component can be obtained by removing the low molecular component from cellulose acylate synthesized according to the usual process. Removal of the low molecular component can be performed by washing the cellulose acylate with a suitable organic solvent. Additionally, in the case of producing cellulose acylate containing a less amount of the low molecular component, it is preferred to adjust the amount of the sulfuric acid catalyst in the acetylation reaction to 0.5 to 25 parts by mass per 100 parts by mass of cellulose acylate. When the amount of the sulfuric acid catalyst is adjusted to the above-mentioned range, there can be synthesized a cellulose acylate also favorable in the point of molecular mass distribution (having a uniform molecular weigh distribution).

In the case of using the cellulose acylate for producing a film, its water content is preferably 2% by mass or less, more preferably 1% by mass or less, particularly preferably 0.7% by mass or less. Cellulose acylate generally contains water, and the content of water is known to be from 2.5 to 5% by mass. In the invention, drying of the film is required in order to adjust the water content of cellulose acylate to a level within the above-described preferred range. The drying method is not particularly limited as long as the water content can be adjusted to the intended level.

As to the raw cotton and synthesizing process of the cellulose acylate, those raw cottons and synthesizing processes can be employed which are described in detail in Hatsumei Kyokai Kokai Giho, Kogi No. 2001-1745 (published on Mar. 15, 2001 by Hatsumei Kyokai), pp. 7-12.

A cellulose acylate film of the invention can be obtained by forming a film using a solution of the specific cellulose acylate and, if necessary, additives in an organic solvent.

### [Additives]

Examples of additives to be used in the invention in the cellulose acylate solution include a plasticizer, a UV ray absorbent, a deterioration-preventing agent, a retardation (optical anisotropy) increasing agent, a retardation (optical anisotropy) decreasing agent, fine particles, a peeling accelerator and an infrared ray absorbent. In the invention, use of a retardation increasing agent is preferred. Also, use of at least one of a plasticizer, a UV ray absorbent and a peeling accelerator is preferred.

They may be a solid or an oily material. That is, they are not particularly limited as to their melting points or boiling points. For example, it is possible to mix a UV ray absorbent having a melting point of 20° C. or less with a UV ray absorbent having a melting point of 20° C. or more to use. Likewise, plasticizers may be mixed to use. Descriptions thereon are given in, for example, JP-A-2001-151901.

As the UV ray absorbent, any kind of UV ray absorbents may be selected according to purpose. There may be used salicylate series, benzophenone series, benzotriazole series; benzoate series, cyanoacrylate series and nickel complex salt series UV ray absorbents. Of these, benzophenone series, benzotriazole series and salicylate series UV ray absorbents are preferred.

Examples of the benzophenone series UV ray absorbent include 2,4-dihydroxybenzophenone, 2-hydroxy-4-acetoxybenzophenone, 2-hydroxy-4-methoxybenzophenone, 2,2′-di-hydroxy-4-methoxybenzophenone, 2,2′-dihydroxy-4,4′-methoxybenzophenone, 2-hydroxy-4-n-octoxybenzophenone, 2-hydroxy-4-dodecyloxybenzophenone and 2-hydroxy-4-(2-hydroxy-3-methacryloxy)propoxybenzophenone.

Examples of the benzotriazole series UV ray absorbent include 2(2′-hydroxy-3′-tert-butyl-5′-methylphenyl)-5-chlorobenzotriazole, 2(2′-hydroxy-5′-t-butylphenyl)benzotriazole, 2(2′-hydroxy-3′,5′-di-t-amylphenyl)benzotriazole, 2(2′-hydroxy-3′,5′-di-t-butylphenyl)-5-chlorobenzotriazole and 2(2′-hydroxy-5′-t-octylphenyl)benzotriazole.

Examples of the salicylate series UV ray absorbent include phenyl salicylate, p-octylphenyl salicylate and p-tert-butylphenyl salicylate.

Of these illustrative UV ray absorbents, 2-hydroxy-4-methoxybenzophenone, 2,2′-di-hydroxy-4,4′-methoxybenzophenone, 2(2′-hydroxy-3′-t-butyl-5′-methylphenyl)-5-chlorobenzotriazole, 2(2′-hydroxy-5′-t-butylphenyl)benzotriazole, 2(2′-hydroxy-3′,5′-di-t-amylphenyl)benzotriazole and 2(2′-hydroxy-3′,5′-di-t-butylphenyl)-5-chlorobenzotriazole are particularly preferred.

Use of a mixture of plural UV ray absorbents different from each other in absorption wavelength is preferred because a high shielding effect is obtained over a wide wavelength region. As a UV ray absorbent for a liquid crystal, those which have an excellent ability of absorbing UV rays of 370 nm or shorter in wavelength and less absorb visible light of 400 nm or longer in wavelength are preferred in view of preventing deterioration of liquid crystal and in view of liquid crystal display performance, respectively. Particularly preferred UV ray absorbents are the aforementioned benzotriazole series compounds, benzophenone series compounds and salicylate series compounds. Among them, benzotriazole series compounds are preferred since they cause less coloration of cellulose which coloration is unnecessary.

Also, as the UV ray absorbents, those compounds can be used as well which are described in JP-A-60-235852, JP-A-3-199201, JP-A-5-1907073, JP-A-5-194789, JP-A-5-271471, JP-A-6-107854, JP-A-6-118233, JP-A-6-148430, JP-A-7-11056, JP-A-7-11055, JP-A-7-11056, JP-A-8-29619, JP-A-8-239509 and JP-A-2000-204173.

The addition amount of the UV ray absorbent is preferably from 0.001 to 5% by mass, more preferably from 0.01 to 1% by mass. An addition amount equal to or more than 0.001% by mass is preferred because the additive can fully exert its effects, and an addition amount equal to or less than 5% by mass is preferred because breed-out of the UV ray absorbent onto the surface of the film can be suppressed.

It is also possible to add the UV ray absorbent simultaneously with dissolution of cellulose acylate, or may be added to a dope after dissolution. In particular, an embodiment is preferred wherein a solution of a UV ray absorbent is added immediately before casting using a static mixer, because it facilitates adjustment of spectral absorption characteristics.

### [Deterioration-Preventing Agent]

The deterioration-preventing agent can prevent deterioration and decomposition of cellulose triacetate or the like. As the deterioration-preventing agent, there are illustrated butylamine, hindered amine compounds (JP-A-8-325537), guanidine compounds (JP-A-5-271471), benzotriazole series UV ray absorbents (JP-A-6-235819) and benzophenone series UV ray absorbents (JP-A-6-118233).

As the plasticizer, phosphates and carboxylates are preferred. The plasticizers are more preferably those which are selected from among triphenyl phosphate (TPP), tricresyl phosphate (TCP), cresyldiphenyl phosphate, octyldiphenyl phosphate, biphenyldiphenyl phosphate (BDP), trioctyl phosphate, tributyl phosphate, dimethyl phthalate (DMP), diethyl phthalate (DEP), dibutyl phthalate (DBP), dioctyl phthalate (DOP), diphenyl phthalate (DPP), diethylhexyl phahalate (DEHP), triethyl O-acetylcitrate (OACTE), triethyl acetylcitrate, tributyl acetylcitrate, butyl oleate, methyl acetylricinolate, dibutyl sebacate, triacetin, tributyrin, butylphthalylbutyl glycolate, ethylphthalylethyl glycolate, methylphthalylethyl glycolate and butylphthalylbutyl glycolate. Further, the plasticizers are preferably (di)pentaerythritol esters, glycerol esters and diglycerol esters.

As examples of the peeling accelerators, there are illustrated ethyl esters of citric acid. Further, infrared absorbents are described in, for example, JP-A-2001-194522.

As to the stage of adding the additives, they may be added in any stage of the dope-preparing step or, alternatively, a step of adding the additives may be additionally provided after the final stage of the dope-preparing step. Further, the addition amount of each material is not particularly limited as long as its function can be obtained. Also, in the case where the cellulose acylate film has a multi-layered structure, kinds and addition amounts of the additives for respective layers may be different. For example, related descriptions are given in JP-A-2001-151902, which are conventionally known techniques. It is preferred to adjust the glass transition point Tg of the cellulose acylate film measured by means of a dynamic viscoelasticity-measuring machine “Vibron DVA-225” (manufactured by IT Keisoku Seigyo K.K.) to 70 to 150° C. and the modulus of elasticity of the cellulose acylate film measured by means of a tensile tester “Storograph-R2” (manufactured by K.K. Toyo Seiki Seisakusho) to 1500 to 4000 MPa by selecting the kinds and the amounts of the additives. The glass transition point Tg is more preferably 80 to 135° C., and the modulus of elasticity is more preferably 1500 to 3000 MPa. That is, the cellulose acylate film to be used in the invention preferably has a glass transition point Tg and a modulus of elasticity within the above-mentioned ranges, respectively, in view of processability of a polarizing plate and adaptability to a process of assembling a liquid crystal display device.

As to the additives, those which are described in Hatsumei Kyokai Kokai Giho, Kogi No. 2001-1745 (published by Hatsumei Kyokai on Mar. 15, 2001), p. 16 et seq. may properly be used.

### (Retardation Increasing Agent)

In the invention, in the case of largely increasing optical anisotropy to realize a preferred retardation value, it is preferred to use a retardation increasing agent.

As a retardation increasing agent to be used in the invention, there may be illustrated those which comprise a rod-like or discotic compound.

As the rod-like or discotic compound, those which have at least two aromatic rings may be used.

The addition amount of the retardation increasing agent comprising a rod-like compound is preferably from 0.1 to 30 parts by mass, more preferably from 0.5 to 20 parts by mass, per 100 parts by mass of the polymer component including cellulose acylate.

The discotic retardation increasing agent is used in an amount of preferably from 0.1 to 30 parts by mass, more preferably from 0.5 to 20 parts by mass, particularly preferably from 3 to 10 parts by mass, per 100 parts by mass of the polymer component including cellulose acylate.

In the case where a particularly large Rth retardation is required, the discotic compound is preferably used because it has a more excellent Rth retardation increasing ability than that of the rod-like compound.

Two or more kinds of retardation increasing agents may be used in combination thereof.

The retardation increasing agent comprising the rod-like or discotic compound has the maximum absorption in the wavelength region of preferably 250 to 400 nm and preferably has substantially no absorption in the visible region.

### (Discotic Compound)

The discotic compound will be described below.

As the discotic compound, those compounds may be used which have at least two aromatic rings.

The term “aromatic ring” as used herein includes aromatic hetero rings in addition to aromatic hydrocarbon rings.

The aromatic hydrocarbon ring is particularly preferably a 6-membered ring (i.e., benzene ring). In general, the aromatic hetero ring is an unsaturated hetero ring. The aromatic hetero ring is preferably a 5-, 6- or 7-membered ring, with a 5- or 6-membered ring being more preferred.

The aromatic hetero ring generally has the maximum double bonds.

As the hetero atom, nitrogen atom, oxygen atom and sulfur atom are preferred, with nitrogen atom being particularly preferred. Examples of the aromatic hetero ring include a furan ring, a thiophene ring, a pyrrole ring, an oxazole ring, an isoxazole ring, a thiazole ring, an isothiazole ring, an imidazole ring, a pyrazole ring, a furazane ring, a triazole ring, a pyran ring, a pyridine ring, a pyridazine ring, a pyrimidine ring, a pyrazine ring and a 1,3,5-triazine ring. As the aromatic ring, a benzene ring, a furan ring, a thiophene ring, a pyrrole ring, an oxazole ring, a thiazole ring, an imidazole ring, a triazole ring, a pyridine ring, a pyrimidine ring, a pyrazine ring and a 1,3,5-triazine ring are preferred, with a 1,3,5-triazine ring being particularly preferably used. Specifically, compounds disclosed in, for example, JP-A-2001-166144 are preferably used as the discotic compound.

The number of aromatic rings the discotic compound has is preferably from 2 to 20, more preferably from 2 to 12, still more preferably from 2 to 8, most preferably from 2 to 6.

Binding relations of two aromatic rings can be classified into (a) the case of forming a condensed ring system, (b) the case of the two aromatic rings being directly connected to each other through a single bond, and (c) the case of the two aromatic rings being connected to each other through a linking group (spiro-union not being formed since the two rings are aromatic rings). The binding relation may be any of (a) to (c).

Examples of the condensed ring system (a) (condensed ring system containing two or more aromatic rings) include an indene ring, a naphthalene ring, an azulene ring, a fluorene ring, a phenanthrene ring, an anthracene ring, an acenaphthylene ring, a biphenylene ring, a naphthacene ring, a pyrene ring, an indole ring, a benzofuran ring, a benzothiophene ring, an indolizine ring, a benzoxazole ring, a benzothiazole ring, a benzimidazole ring, a benzotriazole ring, a purine ring, an indazole ring, a chromene ring, a quinoline ring, an isoquinoline ring, a quinolizine ring, a quinazoline ring, a cinnoline ring, a quinoxaline ring, a phthalazine ring, a pteridine ring, a carbazole ring, an acridine ring, a phenanthridine ring, a xanthene ring, a phenazine ring, a phenothiazine ring, a phenoxathine ring, a phenoxazine ring and a thianthrene ring. Of these, a naphthalene ring, an azulene ring, an indole ring, a benzoxazole ring, a benzothiazole ring, a benzimidazole ring, a benzotriazole ring and a quinoline ring are preferred.

The single bond (b) is preferably a bond between carbon atoms of two aromatic rings. Two aromatic rings may be connected to each other by two or more single bonds to form an alicyclic ring or a non-aromatic hetero ring between the two aromatic rings.

The linking group (c) is preferably a group connecting carbon atoms of two aromatic rings as well. The linking group is preferably an alkylene group, an alkenylene group, an alkynylene group, —CO—, —O—, —NH—, —S— or the combination thereof.

Examples of the linking group comprising the combination are shown below. Additionally, the relation between the right side and the left side of each example of the linking group may be reversed.

c₁: —CO—O—
c₂: —CO—NH—
c₃: -alkylene-O—
c₄: —NH—CO—NH—
c₅: —NH—CO—O—
c₆: —O—CO—O
c₇: —O-alkylene-O—
c₈: —CO-alkenylene-
c₉: —CO-alkenylene-NH—
c₁₀: —CO-alkenylene-O—
c₁₁: -alkylene-CO—O-alkylene-O—CO-alkylene-
c₁₂: —O-alkylene-CO—O-alkylene-O—CO-alkylene-O—

### C₁₃: —O—CO-alkylene-CO—O—

### C₁₄: —NH—CO-alkenylene-

c₁₅: —O—CO-alkenylene-

The aromatic ring and the linking group may have a substituent.

Examples of the substituent include a halogen atom (F, Cl, Br or I), a hydroxyl group, a carboxyl group, a cyano group, an amino group, a nitro group, a sulfo group, a carbamoyl group, a sulfamoyl group, a ureido group, an alkyl group, an alkenyl group, an alkynyl group, an aliphatic acyl group, an aliphatic acyloxy group, an alkoxy group, an alkoxycarbonyl group, an alkoxycarbonylamino group, an alkylthio group, an alkylsulfonyl group, an aliphatic amido group, an aliphatic sulfonamido group, an aliphatic substituted amino group, an aliphatic substituted carbamoyl group, an aliphatic substituted sulfamoyl group, an aliphatic substituted ureido group and a non-aromatic hetero ring group.

The alkyl group preferably has 1 to 8 carbon atoms. A chain alkyl group is more preferred than a cyclic alkyl group, with a straight-chain alkyl group being particularly preferred. The alkyl group may further have a substituent (e.g., a hydroxyl group, a carboxyl group, an alkoxy group or an alkyl-substituted amino group). Examples of the alkyl group (including substituted alkyl groups) include a methyl group, an ethyl group, a n-butyl group, a n-hexyl group, a 2-hydroxyethyl group, a 4-carboxybutyl group, a 2-methoxyethyl group and a 2-diethylaminoethyl group.

The alkenyl group preferably has 2 to 8 carbon atoms. A chain alkenyl group is more preferred than a cyclic alkenyl group, with a straight-chain alkenyl group being particularly preferred. The alkenyl group may further have a substituent. Examples of the alkenyl group include a vinyl group, an allyl group and a 1-hexenyl group.

The alkynyl group preferably has 2 to 8 carbon atoms. A chain alkynyl group is more preferred than a cyclic alkynyl group, with a straight-chain alkynyl group being particularly preferred. The alkynyl group may further have a substituent. Examples of the alkynyl group include an ethynyl group, a 1-butynyl group and a 1-hexynyl group.

The aliphatic acyl group preferably has 1 to 10 carbon atoms. Examples of the aliphatic acyl group include an acetyl group, a propanoyl group and a butanoyl group.

The aliphatic acyloxy group preferably has 1 to 10 carbon atoms. Examples of the aliphatic acyloxy group include an acetoxy group.

The alkoxy group preferably has 1 to 8 carbon atoms. The alkoxy group may further have a substituent (e.g., an alkoxy group). Examples of the alkoxy group (including substituted alkoxy groups) include a methoxy group, an ethoxy group, a butoxy group and a methoxyethoxy group.

The alkoxycarbonyl group preferably has 2 to 10 carbon atoms. Examples of the alkoxycarbonyl group include a methoxycarbonyl group and an ethoxycarbonyl group.

The alkoxycarbonylamino group preferably has 2 to 10 carbon atoms. Examples of the alkoxycarbonylamino group include a methoxycarbonylamino group and an ethoxycarbonylamino group.

The alkylthio group preferably has 1 to 12 carbon atoms. Examples of the alkylthio group include a methylthio group, an ethylthio group and an octylthio group.

The alkylsulfonyl group preferably has 1 to 8 carbon atoms. Examples of the alkylsulfonyl group include a methanesulfonyl group and an ethanesulfonyl group.

The aliphatic amido group preferably has 1 to 10 carbon atoms. Examples of the amido group include an acetamido group.

The aliphatic sulfonamido group preferably has 1 to 8 carbon atoms. Examples of the sulfonamido group include a methanesulfonamido group, a butanesulfonamido group and a n-octanesulfonamido group.

The aliphatic substituted amino group preferably has 1 to 10 carbon atoms. Examples of the aliphatic substituted amino group include a dimethylamino group, a diethylamino group and a 2-carboxyethylamino group.

The aliphatic substituted carbamoyl group preferably has 2 to 10 carbon atoms. Examples of the aliphatic substituted carbamoylo group include a methylcarbamoyl group and a diethylcarbamoyl group.

The aliphatic substituted sulfamoyl group preferably has 1 to 8 carbon atoms. Examples of the aliphatic substituted sulfamoyl group include a methylsulfamoyl group and a diethylsulfamoyl group.

The aliphatic substituted ureido group preferably has 2 to 10 carbon atoms. Examples of the aliphatic substituted ureido group include a methylureido group.

Examples of the non-aromatic hetero ring include a piperidino group and a morpholino group.

The molecular mass of the retardation increasing agent comprising the discotic compound is preferably 300 to 800.

In the invention, rod-like compounds having a linear molecular structure also can preferably be used as well as the aforesaid discotic compounds.

The phrase “linear molecular structured” as used herein means that the molecular structure of the rod-like compound in the thermodynamically most stable structure is linear. The thermodynamically most stable structure can be determined by structural analysis of crystal or by calculating molecular orbital. For example, the molecular orbital calculation can be conducted by using a molecular orbital-calculating soft {for example, “WinMOPAC2000” manufactured by Fujitsu K.K.} to determine the molecular structure with which heat of formation of the compound becomes minimum. The phrase “the molecular structure is linear” as used herein means that, in the thermodynamically most stable structure which can be calculated as described above, the angle formed by the main chain of the molecular structure is 140° or more.

As the rod-like compound, those compounds are preferred which have at least two aromatic rings. The rod-like compounds having at least two aromatic rings are preferably compounds represented by the following formula (1):

Ar¹-L1-Ar² Formula (1)

In the above formula (1), Ar¹ and Ar² each independently represents an aromatic group.

In this specification, the aromatic group includes an aryl group (aromatic hydrocarbon group), a substituted aryl group, an aromatic hetero ring group and a substituted aromatic hetero ring group. The aryl group and the substituted aryl group are more preferred than the aromatic hetero ring group and the substituted aromatic hetero ring group.

The aromatic ring of the aromatic hetero ring group is generally unsaturated. The aromatic hetero ring is preferably a 5-, 6- or 7-membered ring, more preferably a 5- or 6-membered ring. The aromatic hetero ring generally has the maximum number of double bonds. As the hetero atom, nitrogen atom, oxygen atom or sulfur atom is preferred, with nitrogen atom or sulfur atom being more preferred.

As the aromatic ring of the aromatic group, a benzene ring, a furan ring, a thiophene ring, a pyrrole, ring, an oxazole ring, a thiazole ring, an imidazole ring, a triazole ring, a pyridine ring, a pyrimidine ring and a pyrazine ring are preferred, with a benzene ring being particularly preferred.

Examples of the substituent for the substituted aryl group and the substituted aromatic hetero ring group include a halogen atom (F, Cl, Br or I), a hydroxyl group, a carboxyl group, a cyano group, an amino group, an alkylamino group (e.g., a methylamino group, an ethylamino group, a butylamino group or a dimethylamino group), a nitro group, a sulfo group, a carbamoyl group, an alkylcarbamoyl group (e.g., an N-methylcarbamoyl group, an N-ethylcarbamoyl group or an N,N-dimethylcarbamoyl group), a sulfamoyl group, an alkylsulfamoyl group (e.g., an N-methylsulfamoyl group, an N-ethylsulfamoyl group or an N,N-dimethylsulfamoyl group), a ureido group, an alkylureido group (e.g., an N-methylureido group, an N,N-dimethylureido group or an N,N,N-trimethylureido group), an alkyl group (e.g., a methyl group, an ethyl group, a propyl group, a butyl group, a pentyl group, a heptyl group, an octyl group, an isopropyl group, a s-butyl group, a t-amyl group, a cyclohexyl group or a cyclopentyl group), an alkenyl group (e.g., a vinyl group, an allyl group or a hexenyl group), an alkynyl group (e.g., an ethynyl group or a butynyl group), an acyl group (e.g., a formyl group, an acetyl group, a butyryl group, a hexanoyl group or a lauryl group), an acyloxy group (e.g., an acetoxy group, a butyryloxy group, a hexanoyloxy group or a lauryloxy group), an alkoxy group (e.g., a methoxy group, an ethoxy group, a propoxy group, a butoxy group, a pentyloxy group, a heptyloxy group or an octyloxy group), an aryloxy group (e.g., a phenoxy group), an alkoxycarbonyl group (e.g., a methoxycarbonyl group, an ethoxycarbonyl group, a propoxycarbonyl group, a butoxycarbonyl group, a pentyloxycarbonyl group or a heptyloxycarbonyl group), an aryloxycarbonyl group (e.g., a phenoxycarbonyl group), an alkoxycarbonylamino group (e.g., a butoxycarbonylamino group or a hexyloxycarbonylamino group), an alkylthio group (e.g., a methylthio group, an ethylthio group, a propylthio group, a butylthio group, a pentylthio group, a heptylthio group or an octylthio group), an arylthio group (e.g., a phenylthio group), an alkylsulfonyl group (e.g., a methylsulfonyl group, an ethylsulfonyl group, a propylsulfonyl group, a butylsulfonyl group, a pentylsulfonyl group, a heptylsulfonyl group or an octylsulfonyl group), an amido group (e.g., an acetamido group, a butyramido group, a hexanoylamido group or a lauroylamido group) and a non-aromatic hetero ring group (e.g., a morpholino group or a pyrazinyl group).

As the substituent of the substituted aryl group and the substituted aromatic hetero ring group, a halogen atom, a cyano group, a carboxyl group, a hydroxyl group, an amino group, an alkyl-substituted amino group, an acyl group, an acyloxy group, an amido group, an alkoxycarbonyl group, an alkoxy group, an alkylthio group and an alkyl group are preferred.

The alkyl moiety of the alkylamino group, alkoxycarbonyl group, alkoxy group and alkylthio group and the alkyl group may further have a substituent. Examples of the substituent for the alkyl moiety and the alkyl group include a halogen atom, a hydroxyl group, a carboxyl group, a cyano group, an amino group, an alkylamino group, a nitro group, a sulfo group, a carbamoyl group, an alkylcarbamoyl group, a sulfamoyl group, an alkylsulfamoyl group, a ureido group, an alkylureido group, an alkenyl group, an alkynyl group, an acyl group, an acyloxy group, an acylamino group, an alkoxy group, an aryloxy group, an alkoxycarbonyl group, an aryloxycarbonyl group, an alkoxycarbonylamino group, an alkylthio group, an arylthio group, an alkylsulfonyl group, an amido group and a non-aromatic hetero ring group. As the substituent for the alkyl moiety and the alkyl group, a halogen atom, a hydroxyl group, an amino group, an alkylamino group, an acyl group, an acyloxy group, an acylamino group, an alkoxycarbonyl group and an alkoxy group are preferred.

In the foregoing formula (1), L¹ is a divalent linking group selected from among an alkylene group, an alkenylene group, an alkynylene group, —O—, —CO— and the combination thereof.

The alkylene group may have a cyclic structure. As the cyclic alkylene group, cyclohexylene is preferred, with 1,4-cyclohexylene being particularly preferred. As a chain alkylene group, a straight-chain alkylene group is more preferred than an alkylene group having a branch. The alkylene group preferably has 1 to 20 carbon atoms, more preferably 1 to 15 carbon atoms, still more preferably 1 to 10 carbon atoms, yet more preferably 1 to 8 carbon atoms, most preferably 1 to 6 carbon atoms.

It is more preferred for the alkenylene group and the alkynylene group to have a chain structure than to have a cyclic structure, and it is still more preferred for them to have a straight chain structure than to have a branched chain structure. The alkenylene group and the alkynylene group preferably have 2 to 10 carbon atoms, more preferably 2 to 8 carbon atoms, still more preferably 2 to 6 carbon atoms, yet more preferably 2 to 4 carbon atoms, most preferably 2 carbon atoms (vinylene or ethynylene).

The arylene group preferably has 6 to 20 carbon atoms, more preferably 6 to 16 carbon atoms, still more preferably 6 to 12 carbon atoms.

In the molecular structure of formula (1), the angle formed by Ar¹ and Ar² is preferably 140° or more.

As the rod-like compounds, those compounds are more preferred that are represented by the following formula (2):

Ar¹-L²-X-L³-Ar³ Formula (2)

In the above formula (2), Ar1 and Ar2 each independently represents an aromatic group.

Definition and examples of the aromatic group are the same as with Ar¹ and Ar² in the formula (1). In the above formula (2), L² and L³ each independently represents a divalent group selected from among an alkylene group, —O—, —CO— and the combination thereof.

It is more preferred for the alkylene group to have a chain structure than to have a cyclic structure, and it is still more preferred for the alkylene group to have a straight chain structure than to have a branched chain structure. The alkylene group preferably has 1 to 10 carbon atoms, more preferably 1 to 8 carbon atoms, still more preferably 1 to 6 carbon atoms, yet more preferably 1 to 4 carbon atoms, most preferably 1 or 2 carbon atoms (methylene or ethylene).

L² and L³ are particularly preferably —O—CO— or —CO—O—.

In formula (2), X is 1,4-cyclohexylene, vinylene or ethynylene.

As specific examples of the compounds represented by formula (1) or (2), there are illustrated compounds described in JP-A-2004-109657, [Ka1] to [Ka11].

Other preferred compounds are shown below.

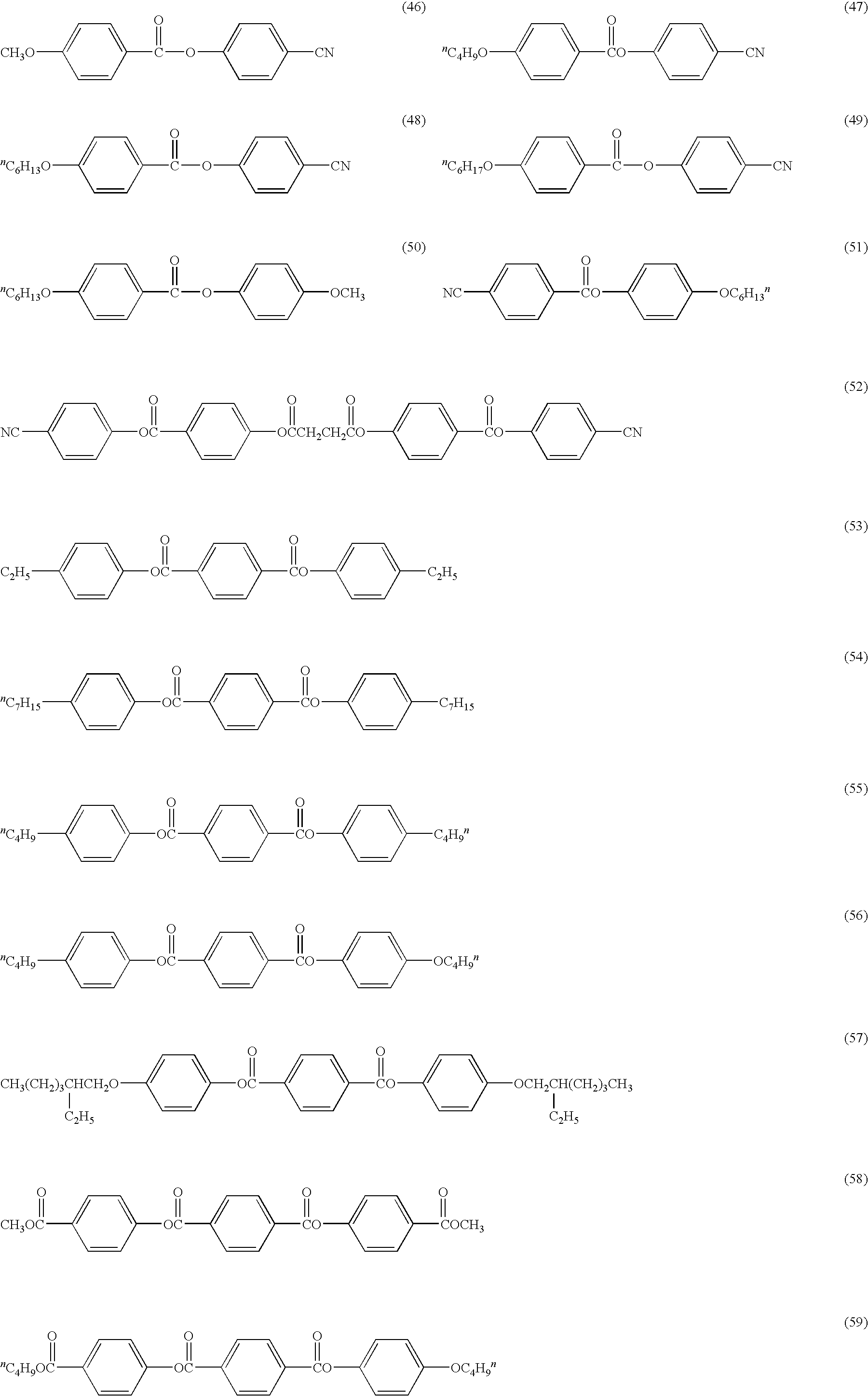

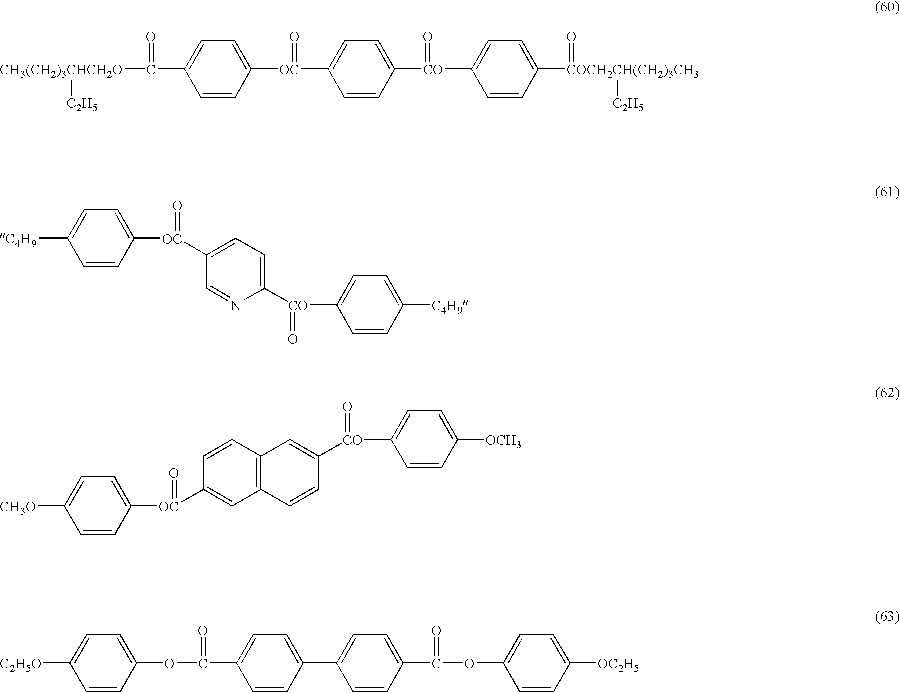

Two or more of the rod-like compounds whose solution has the maximum absorption wavelength (λₘₐₓ) of 250 nm or shorter in the UV ray absorption spectrum may be used in combination thereof.

The rod-like compounds can be synthesized according to processes described in literatures.

Examples of such literatures include Mol. Cryst. Liq. Cryst., 53, 229 (1979); ibid., 89, 93 (1982); ibid., 145, 111 (1987); ibid., 170, 43 (1989); J. Am. Chem. Soc., 113, 1349 (1991); ibid., 118, 5346 (1996); ibid., 92, 1582 (1970); J. Org. Chem., 40, 420 (1975); and Tetrahedron, 48, No. 16, p. 3437 (1992).

### [Fine Particles of Matt Agent]

It is preferred to add fine particles as a matt agent to the cellulose acylate film of the invention. As the fine particles to be used in the invention, fine particles of silicon dioxide, titanium dioxide, aluminum oxide, zirconium oxide, calcium carbonate, talc, clay, calcined kaolin, calcined calcium silicate, calcium silicate hydrate, aluminum silicate, magnesium silicate and calcium phosphate. Fine particles containing silicon are preferred in the point that they give a reduced turbidity, with silicon dioxide being particularly preferred.

As the fine particles of silicon dioxide, those which have a primary average particle size of 20 nm or less and an apparent specific gravity of 70 g/L or more are preferred. Those which have a primary average particle size as small as 5 to 16 nm are more preferred because they can reduce a haze value of the resulting film. The apparent specific gravity is preferably from 90 to 200 g/L or more, more preferably from 100 to 200 g/L or more. A higher apparent specific gravity permits preparation of a more, concentrated dispersion, which serves to reduce haze and prevent formation of agglomerates, thus being preferred.

In the case of using fine particles of silicon dioxide described above, the amount thereof to use is preferably from 0.01 to 0.3 part by mass per 100 parts by mass of a polymer component including cellulose acylate.

These fine particles usually form secondary particles of 0.1 to 3.0 μm in average particle size but, in the film, they exist as agglomerates of primary particles, forming unevenness of 0.1 to 3.0 μm on the film surface. The average particle size of the secondary particles is preferably from 0.2 μm to 1.5 μm, more preferably from 0.4 μm to 1.2 μm, most preferably from 0.6 μm to 1.1 μm. When the average particle size is larger than 1.5 μm, there result too strong haze and, when the average particle size is less than 0.2 μm, there can be obtained only a reduced effect of preventing squeak.

As to the size of primary and secondary particles of the fine particles, particles in the film are observed by means of a scanning type electron microscope, and a diameter of a circle circumscribing each particle is taken as a particle size. Also, regarding average particle size, 200, particles in different portions are observed, and the diameters are averaged to determine the average particle size.

As the fine particles of silicon dioxide, commercially available products such as “AEROSIL” R972, R972V, R974, R812, 200, 200V, 300, R202, OX50 and TT600 (these being manufactured by Nippon Aerosil K.K.) can be used. Fine particles of zirconium oxide are commercially available under the trade name of, for example, “AEROSIL” R976 and R811 (these being manufactured by Nippon Aerosil K.K.) and can be used.

Of these, “AEROSIL 200V” and “AEROSIL R972V” are particularly preferred, because they are fine particles of silicon dioxide having an average particle size of primary particles of 20 nm or less and an apparent specific gravity of 70 g/L or more and exhibit the effect of reducing the friction factor while keeping turbidity of the film at a low level.

In the invention, in order to obtain a cellulose acylate film containing particles having a small average particle size of secondary particles, there can be considered several methods for preparing a dispersion of the fine particles. For example, there is a method of previously preparing a dispersion of fine particles by stirring a solvent and fine particles to mix, adding this fine particle dispersion to a small amount of a separately prepared cellulose acylate solution, stirring them to mix, and mixing the resulting mixture with a main cellulose acylate dope solution. This method is a preferred preparation method in that good dispersibility of the silicon dioxide fine particles can be obtained and that the silicon dioxide fine particles difficultly agglomerate again. In addition, there is a method of adding a small amount of cellulose ester to a solvent and, after stirring to dissolve, adding thereto fine particles and conducting dispersing operation in a dispersing machine to prepare a solution for adding fine particles, and sufficiently mixing this solution with the dope solution in an in-line mixer. The invention is not limited only to these methods. The concentration of silicon dioxide upon mixing with a solvent to disperse is preferably from 5 to 30% by mass, more preferably from 10 to 25% by mass, most preferably from 15 to 20% by mass.

A higher dispersion concentration serves to reduce turbidity of the solution for a particular addition amount and reduce haze and formation of agglomerates, thus being preferred. The addition amount of the matt agent in the final cellulose acylate dope solution is preferably from 0.01 to 1.0 g, more preferably from 0.03 to 0.3 g, most preferably from 0.08 to 0.16 g, per m².

As the solvent to be used, there are illustrated lower alcohols, preferably methyl alcohol, ethyl alcohol, propyl alcohol, isopropyl alcohol and butyl alcohol. As to other solvents than the lower alcohols, there are no particular restrictions, but a solvent used upon formation of a film of cellulose ester is preferred to use.

Next, the organic solvent of the invention in which cellulose acylate is dissolved will be described below.

In the invention, either of a chlorine-containing solvent containing a chlorine-containing organic solvent as a major component and a chlorine-free solvent not containing a chlorine-containing organic solvent may be used.

### [Chlorine-Containing Solvent]

In preparing a cellulose acylate solution of the invention, a chlorine-containing organic solvent is preferably used as a main solvent. The kind of the chlorine-containing organic solvent is not particularly limited as long as it can dissolve cellulose acylate and permit casting and filming. Such chlorine-containing organic solvents are preferably dichloromethane and chloroform, with dichloromethane being particularly preferred. It does not cause any particular problem to mix with other organic solvent than the chlorine-containing organic solvent. In such cases, dichloromethane is necessary to be used in an amount of at least 50% by mass based on the whole mass of the organic solvents.

Other organic solvents to be used in the invention in combination with the chlorine-containing organic solvent will be described below.

That is, as other organic solvents, those solvents are preferred which are selected from among esters, ketones, ethers, alcohols and hydrocarbons containing from 3 to 12 carbon atoms. The esters, ketones, ethers and alcohols may have a cyclic structure. Compounds having two or more of the functional groups of ester, ketone and ester (i.e., —O—, —CO— and —COO—) can also be used as the solvents. They may have at the same time other functional groups such as a hydroxyl group. With solvents having two or more functional groups, it suffices for the number of carbon atoms to be within the range for one of the functional group. Examples of esters containing from 3 to 12 carbon atoms include ethyl formate, propyl formate, pentyl formate, methyl acetate, ethyl acetate and pentyl acetate. Examples of ketones containing from 3 to 12 carbon atoms include acetone, methyl ethyl ketone, diethyl ketone, diisopropyl ketone, cyclopentanone, cyclohexanone and methylcyclohexanone. Examples of ethers containing from 3 to 12 carbon atoms include diisopropyl ether, dimethoxymethane, dimethoxyethane, 1,4-dioxane, 1,3-dioxolan, tetrahydrofuran, anisole and phenetole. Examples of organic solvents having two or more functional groups include 2-ethoxyethyl acetate, 2-methoxyethanol and 2-butoxyethanol.

Alcohols to be used in combination with the chlorine-containing organic solvent may be straight, branched or cyclic, with saturated aliphatic hydrocarbons being preferred. The hydroxyl group of the alcohol may be any of primary to tertiary hydroxyl groups. Examples of the alcohol include methanol, ethanol, 1-propanol, 2-propanol, 1-butanol, 2-butanol, t-butanol, 1-pentanol, 2-methyl-2-butanol and cyclohexanol. Additionally, fluorine-containing alcohols may also be used. Examples thereof include 2-fluoroethanol, 2,2,2-trifluoroethanol and, 2,2,3,3-tetrafluoro-1-propanol. Further, the hydrocarbons may be straight, branched or cyclic. Either of aromatic hydrocarbons and aliphatic hydrocarbons may be used. The aliphatic hydrocarbons may be saturated or unsaturated. Examples of the hydrocarbons include cyclohexane, hexane, benzene, toluene and xylene.

Examples of a combination of the chlorine-containing organic solvent and other organic solvent are illustrated below which, however, are not limitative at all.

Dichloromethane/methanol/ethanol/butanol=80/10/5/5 (parts by mass)
Dichloromethane/acetone/methanol/propanol=80/10/5/5 (parts by mass)
Dichloromethane/methanol/butanol/cyclohexane=80/10/5/5 (parts by mass)
Dichloromethane/methyl ethyl ketone/methanol/butanol=80/10/5/5 (parts by mass)
Dichloromethane/acetone/methyl ethyl ketone/ethanol/isopropanol=75/8/5/5/7 (parts by mass)
Dichloromethane/cyclopentanone/methanol/isopropanol=80/7/5/8 (parts by mass)
Dichloromethane/methyl acetate/butanol=80/10/10 (parts by mass)
Dichloromethane/cyclohexanone/methanol/hexane=70/20/5/5 (parts by mass)
Dichloromethane/methyl ethyl ketoned/acetoned/methanol/ethanol=50/20/20/5/5 (parts by mass)
Dichloromethane/1,3-dioxolan/methanol/ethanol=70/20/5/5 (parts by mass)
Dichloromethane/dioxane/acetone/methanol/ethanol=60/20/10/5/5 (parts by mass)
Dichloromethane/acetone/cyclopentanone/ethanol/iso-propanol/cyclohexane=65/10/10/5/5/5 (parts by mass)
Dichloromethane/methyl ethyl ketoned/acetone/methanol/ethanol=70/10/10/5/5 (parts by mass)
Dichloromethane/acetone/ethyl acetate/ethanol/butanol/hexane=65/10/5/5/5 (parts by mass)
Dichloromethane/methyl acetacetate/methanolo/ethanol=65/20/10/5 (parts by mass)
Dichloromethane/cyclopentanone/ethanol/butanol=65/20/10/5 (parts by mass)

### [Chlorine-Free Solvent]

Next, chlorine-free organic solvents to be preferably used in preparing a cellulose acylate solution which is preferably used in the invention will be described below. In the invention, the kind of the chlorine-free organic solvent is not particularly limited as long as it can dissolve cellulose acylate and permit casting and filming. As the chlorine-free organic solvent to be used in the invention, those solvents are preferred which are selected from among esters, ketones and ethers containing from 3 to 12 carbon atoms. The esters, ketones and ethers may have a cyclic structure. Compounds having two or more of the functional groups of ester, ketone and ester (i.e., —O—, —CO— and —COO—) can also be used as a main solvent. They may have other functional groups such as a hydroxyl group. With main solvents having two or more functional groups, it suffices for the number of carbon atoms to be within the range for one of the functional group. Examples of esters containing from 3 to 12 carbon atoms include ethyl formate, propyl formate, pentyl formate, methyl acetate, ethyl acetate and pentyl acetate. Examples of ketones containing from 3 to 12 carbon atoms include acetone, methyl ethyl ketone, diethyl ketone, diisopropyl ketone, cyclopentanone, cyclohexanone, methylcyclohexanone and methyl acetylacetate. Examples of ethers containing from 3 to 12 carbon atoms include diisopropyl ether, dimethoxymethane, dimethoxyethane, 1,4-dioxane, 1,3-dioxolan, tetrahydrofuran, anisole and phenetole. Examples of organic solvents having two or more functional groups include 2-ethoxyethyl acetate, 2-methoxyethanol and 2-butoxyethanol.

The chlorine-free organic solvents to be used for cellulose acylate are selected from the aforesaid various viewpoints, and are preferably as described below.

That is, as the chlorine-free solvent, a mixed solvent containing the above-described chlorine-free organic solvent as a main solvent is preferred. Such mixed solvent is a mixed solvent of three or more solvents different from each other wherein the first solvent is at least one solvent selected from among methyl acetate, ethyl acetate, methyl formate, ethyl formate, acetone, dioxolan and dioxane or a mixture thereof, the second solvent is selected from among ketones and acetoacetates having from 4 to 7 carbon atoms, and the third solvent is selected from among alcohols and hydrocarbons containing from 1 to 10 carbon atoms, more preferably from among alcohols containing from 1 to 8 carbon atoms. Additionally, in the case where the first solvent is a mixed liquid of two or more solvents, the second solvent may be omitted. The first solvent is more preferably methyl acetate, acetone, methyl formatted, ethyl formate or a mixture thereof, and the second solvent is preferably methyl ethyl ketone, cyclopentanone, cyclohexanone or methyl acetylacetate or may be a mixed solvent thereof.

The hydrocarbon chain of the third solvent alcohol may be straight, branched or cyclic, with a saturated aliphatic hydrocarbon chain being preferred. The hydroxyl group of the alcohol may be any of primary to tertiary hydroxyl groups. Examples of the alcohol include methanol, ethanol, 1-propanol, 2-propanol, 1-butanol, 2-butanol, t-butanol, 1-pentanol, 2-methyl-2-butanol and cyclohexanol. Additionally, as the alcohols, fluorine-containing alcohols wherein part or the whole of hydrogen atoms of the hydrocarbon chain are substituted by fluorine atom may also be used. Examples thereof include 2-fluoroethanol, 2,2,2-trifluoroethanol and 2,2,3,3-tetrafluoro-1-propanol.

Further, the hydrocarbons may be straight, branched or cyclic. Either of aromatic hydrocarbons and aliphatic hydrocarbons may be used. The aliphatic hydrocarbons may be saturated or unsaturated. Examples of the hydrocarbons include cyclohexane, hexane, benzene, toluene and xylene.

These third solvent alcohols may be used alone or as a mixture of two or more thereof with no particular limitation. As the third solvent, preferred specific examples of alcohols include methanol, ethanol, 1-propanol, 2-propanol, 1-butanol, 2-butanol and cyclohexanol and preferred specific examples of hydrocarbons include cyclohexane and hexane, with methanol, ethanol, 1-propanol, 2-propanol and 1-butanol being particularly preferred

As to the mixing proportion of the three kinds of solvents in the mixed solvent, the first solvent is preferably contained in a content of from 20 to 95% by mass, the second solvent is preferably contained in a content of from 2 to 60% by mass, and the third solvent is preferably contained in a content of from 2 to 30% by mass. More preferably, the first solvent is contained in a content of from 30 to 90% by mass, the second solvent is contained in a content of from 3 to 50% by mass, and the third solvent alcohol is contained in a content of from 3 to 25% by mass. Particularly preferably, the first solvent is contained in a content of from 30 to 90% by mass, the second solvent is contained in a content of from 3 to 30% by mass, and the third solvent alcohol is contained in a content of from 3 to 15% by mass.

The chlorine-free organic solvents to be used in the invention are described in more detail in Hatsumei Kyokai Kokai Giho, Kogi-No. 2001-1745 (published on 15, Mar., 2001

Preferred combinations of the chlorine-free organic solvents are illustrated below which, however, do not limit the invention in any way.

Methyl acetate/acetone/methanol/ethanol/butanol=75/10/5/5/5 (parts by mass)
Methyl acetate/acetone/methanol/ethanol/propanol=75/10/5/5/5 (parts by mass)
Methyl acetate/acetone/methanol/butanol/cyclohexane=75/10/5/5/5 (parts by mass)
Methyl acetate/acetone/ethanol/butanol=81/8/7/4 (parts by mass)
Methyl acetate/acetone/ethanol/butanol=82/10/4/4 (parts by mass)
Methyl acetate/acetone/ethanol/butanol=80/10/4/6 (parts by mass)
Methyl acetate/methyl ethyl ketone/methanol/butanol=80/10/5/5 (parts by mass)
Methyl acetate/acetone/methyl ethyl ketone/ethanol/iso-propanol=75/8/10/5/7 (parts by mass)
Methyl acetate/cyclopentanone/methanol/isopropanol=80/7/5/8 (parts by mass)
Methyl acetate/acetone/butanol=85/10/5 (parts by mass)
Methyl acetate/cyclopentanone/acetone/methanol/butanol=60/15/14/5/6 (parts by mass)
Methyl acetate/cyclohexanone/methanol/hexane=70/20/5/5 (parts by mass)
Methyl acetate/methyl ethyl ketone/acetone/methanol/ethanol=50/20/20/5/5 (parts by mass)
Methyl acetate/1,3-dioxolan/methanol/ethanol=70/20/5/5 (parts by mass)
Methyl acetate/dioxane/acetone/methanol/ethanol=60/20/10/5/5 (parts by mass)
Methyl acetate/acetone/cyclopentanone/ethanol/isopropanol/cyclohexane=65/10/10/5/5/5 (parts by mass)
Methyl formate/methyl ethyl ketone/acetone/methanol/ethanol=50/20/20/5/5 (parts by mass)
Methyl formate/acetone/ethyl acetate/ethanol/butanol/hexane=65/10/10/5/5/5 (parts by mass)
Acetone/methyl acetacetate/methanol/ethanol=65/20/10/5 (parts by mass)
Acetone/cyclopentanone/ethanol/butanol=65/20/10/5 (parts by mass)
Acetone/1,3-dioxolan/ethanol/butanol=65/20/10/5 (parts by mass)
1,3-Dioxolan/cyclohexanone/methyl ethyl ketone/methanol/butanol=55/20/10/5/5/5 (parts by mass)

Further, a cellulose acylate solution prepared by the following method can also be used.

A method of preparing a cellulose acylate solution using a mixed solvent of methyl acetate/acetone/ethanol/butanol=81/8/7/4 (parts by mass) and, after filtration and concentration of the resulting solution, additionally adding thereto 2 parts by mass of butanol.

A method of preparing a cellulose acylate solution using a mixed solvent of methyl acetate/acetone/ethanol/butanol=84/10/4/2 (parts by mass) and, after filtration and concentration of the resulting solution, additionally adding thereto 4 parts by mass of butanol.

A method of preparing a cellulose acylate solution using a mixed solvent of methyl acetate/acetone/ethanol=84/10/6 (parts by mass) and, after filtration and concentration of the resulting solution, additionally adding thereto 5 parts by mass of butanol.

To the dope to be used in the invention may be incorporated dichloromethane in a content of 10% by mass or less based on the amount of all of the organic solvents in addition to the chlorine-free organic solvents of the invention.

### (Characteristic Properties of Cellulose Acylate Solution)

In view of adaptability to formation of a film by casting, the cellulose acylate solution is preferably a solution prepared by dissolving cellulose acylate in the organic solvent in a concentration ranging from 10 to 30% by mass, more preferably from 13 to 27% by mass, particularly preferably from 15 to 25% by mass. In order to adjust the concentration of the cellulose acylate solution to a level within the range, the concentration may be adjusted to a predetermined level at the stage of dissolution, or a solution of a low concentration (e.g., 9 to 14% by mass) may previously be prepared, and the concentration is adjusted to a predetermined high level in the concentrating step to be described hereinafter. Further, after previously preparing a cellulose acylate solution with a high concentration, various additives may be added thereto to lower the concentration to thereby prepare a cellulose acylate solution with a predetermined low concentration. Any of these methods does not involve particular problems as long as they are conducted so as to provide a cellulose acylate solution with a concentration of the invention.

Next, in the invention, it is preferred that the molecular mass of associated molecules of cellulose acylate in a dilute solution thereof obtained by adjusting the concentration of cellulose acylate in an organic mixed solvent of the same formulation as that for the dope solution to 0.1 to 5% by mass be 150,000 to 9,000,000 from the point of view of solubility into the solvent. The molecular mass of the associated molecules is more preferably from 180,000 to 9,000,000. This molecular mass of associated molecules can be determined by the static light-scattering method. Dissolution of the molecules is preferably conducted so that the inertia radius simultaneously determined becomes from 10 to 200 nm, more preferably from 20 to 200 nm. Further, dissolution is preferably conducted so that the second virial coefficient becomes from −2×10⁻⁴ to +4×10⁻⁴, more preferably from −2×10⁻⁴ to +2×10⁻⁴.

Here, definitions of the molecular mass of associated molecules, inertia square radius and second virial coefficient are described below. These are measured in the following manner according to the static light-scattering method. Although measurements are conducted in a dilute region for device's convenience, the measured values reflect the behavior of the dope of the invention in a high concentration region.

First, cellulose acylate is dissolved in a solvent to be used for the dope, thus solutions of 0.1% by mass, 0.2% by mass, 0.3% by mass and 0.4% by mass in concentration being prepared. Additionally, cellulose acylate is weighed at 25° C. and 10% RH using a sample having been dried at 120° C. for 2 hours in order to avoid absorption of moisture by the sample. The dissolving method is conducted according to the method employed upon dissolving the dope (a method of dissolving at an ordinary temperature, a method of dissolving under cooling or a method of dissolving at an elevated temperature). Subsequently, these solutions and solvents are filtered through a 0.2-μm Teflon-made filter. Then, static light scattering of each of the thus-filtered solutions is measured at 25° C. from 30° to 140° at 10° intervals using a light scattering-measuring apparatus “DLS-700” (manufactured by OTSUKA ELECTRONICS CO., LTD.). The thus-obtained data are analyzed according to the BERRY plot method. Additionally, as the refractive index necessary for this analysis, that of the solvent determined by means of an Abbe's refractometer is used, and the concentration gradient of refractive index (dn/dc) is measured by means of a differential refractometer “DRM-1021” (manufactured by OTSUKA ELECTRONICS CO., LTD.) using the solvent and the solution having been used for measuring light scattering.

### [Preparation of Dope]

Next, preparation of a solution (dope) for casting and filming cellulose acylate will be described below.

Methods for dissolving cellulose acylate are not particularly limited, and dissolution may bed conducted by a method of dissolving at a room temperature, a method of dissolving under cooling, a method of dissolving at an elevated temperature or by a combination thereof. As to dissolution, descriptions are given in, for example, JP-A-5-163301, JP-A-61-106628, JP-A-58-127737, JP-A-9-95544, JP-A-10-95854, JP-A-10-45950, JP-A-2000-53784, JP-A-11-322946, JP-A-11-322947, JP-A-2-276830, JP-A-2000-273239, JP-A-11-71463, JP-A-4-259511, JP-A-2000-273184, JP-A-11-323017 and JP-A-11-302388 as methods for preparing a cellulose acylate solution.

Of these methods of dissolving cellulose acylate in an organic solvent, techniques within the scope of the invention can properly be employed. Detailed descriptions on these, particularly chlorine-free solvent system, are given in Hatsumei Kyokai Kokai Giho Kogi No. 2001-1745 (published on 15, Mar. 2001 by Hatsumei Kyokai), pp. 22-25, and dissolution can be conducted according to the methods described there. Further, as to a dope solution of cellulose acylate of the invention, concentration and filtration of the solution are usually conducted, and detailed description thereon are similarly given in Hatsumei Kyokai Kokai Giho Kogi No. 2001-1745 (published on 15, Mar. 2001 by Hatsumei Kyokai), p. 25. Additionally, in the case of dissolving at an elevated temperature, dissolving procedure is in most cases conducted at a temperature higher than the boiling point of the organic solvent and, in such cases, the procedure is conducted under pressure.

The cellulose acylate solution preferably has a viscosity and a dynamic storage modulus of elasticity within the following ranges, respectively, which serves to facilitate casting. These are measured on 1 mL of a sample solution using “Steel Cone” of 4 cm/2° in diameter in a rheometer “CLS 500” (both being manufactured by TA Instruments). As to measuring conditions, a static non-Newtonian viscosity n*(Pa·s) at 40° C. and a storage modulus of elasticity G′(Pa) at −5° C. are determined by measuring in the range of from 40° C. to −10° C. with varying at a rate of 2°/min in Oscillation Step/Temperature Ramp. Additionally, a sample solution is kept at a temperature for measurement till the solution temperature becomes constant before initiation of the measurement.

In the invention, the viscosity at 40° C. is preferably from 1 to 400 Pa·s, more preferably from 10 to 200 Pa·s, and the dynamic storage modulus of elasticity at 15° C. is preferably 500 Pa or more, more preferably from 100 to 1,000,000. Further, the larger the dynamic storage modulus of elasticity at a low temperature, the more preferred. For example, in the case where a support for casting is at −5° C., the dynamic storage modulus of elasticity at −5° C. is preferably from 10,000 to 1,000,000 Pa whereas, in the case where the support is at −50° C., the dynamic storage modulus of elasticity at −50° C. is preferably from 10,000 to 5,000,000 Pa.

In the invention, use of the aforesaid specific cellulose acylate permits to obtain a highly concentrated dope. That is, a highly concentrated cellulose acylate solution having an excellent stability can be obtained without the particular procedure of concentration. It is also possible to first dissolve cellulose acylate at a low concentration in order to facilitate dissolution, and then concentrate the solution using a concentrating means. The concentrating method is not particularly limited, but concentration can be conducted by a method of introducing a low-concentration solution between a housing and a rotation locus of a rotating blade which is provided in the housing and rotates in the peripheral direction while giving a temperature difference from the solution temperature, thus obtaining a highly concentrated solution with evaporating the solvent (e.g., JP-A-4-259511) or a method of blowing a heated low-concentration solution into a vessel through a nozzle to thereby flash evaporate the solvent while the solution travels from the nozzle to the inner wall of the vessel, with removing the solvent vapor from the vessel and recovering a highly concentrated solution from the bottom of the vessel (e.g., U.S. Pat. Nos. 2,541,012, 2,858,229, 4,414,341 and 4,504,355).

The solution is preferably filtered using a filter member such as a wire gauze or flannel to remove insolubles, dusts and impurities before casting. In filtering the cellulose acylate solution, use of a filter of 0.1 to 100 μm in absolute filtration accuracy is preferred, and use of a filter of 0.5 to 25 μm in absolute filtration accuracy is more preferred. The thickness of the filter is preferably from 0.1 to 10 mm, more preferably from 0.2 to 2 mm. In such case, filtration is conducted under a filtering pressure of preferably 1.6 MPa or less, more preferably 1.2 MPa or less, still more preferably 1.0 MPa or less, particularly preferably 0.2 MPa or less. As the filter member, conventionally known materials such as glass fibers, cellulose fibers, filter paper and fluorine-containing resins such as tetrafluoroethylene resin can preferably be used. In particular, ceramics and metals are preferably used. The viscosity of the cellulose acylate solution immediately before forming a film may be within a range which permits casting upon formation of the film, and is usually adjusted to a range of preferably from 10 Pa·s to 2,000 Pa·s, more preferably from 30 Pa·s to 1,000 Pa·s, still more preferably from 40 Pa·s to 500 Pa·s. Additionally, the temperature at this stage is not particularly limited as long as it is the temperature upon casting, but is preferably from −5 to +70° C., more preferably from −5 to +55° C.

### (Film Forming)

The cellulose acylate film of the invention can be obtained by forming a film using the aforesaid cellulose acylate solution (dope). As a method of forming a film and an apparatus for the method, a method of forming a film by casing a solution and an apparatus for forming a film by casting a solution having conventionally been employed for producing a cellulose triacetate film can be employed. A dope (cellulose acylate solution) prepared in a dissolving machine (tank) is once stored in a storage tank to remove foams contained in the dope for preparing a final dope. The dope is discharged through a dope-discharging outlet to a pressure type die via a pressure type quantity-measuring gear pump capable of transporting a definite quantity of a liquid with a high accuracy by controlling rotation number, and the dope is uniformly cast onto an endlessly running metal support in the casting section and, at the peeling point where the metal support makes a round, the half-dried dope film (also called web) is peeled from the metal support. The resulting web is gripped by clips at both edges thereof, and is conveyed by means of a tenter to dry while keeping the width, and subsequently conveyed by a group of rolls of a drying apparatus to complete drying, followed by winding the web in a predetermined length using a winding machine. A combination of the tenter and a group of the rolls varies depending upon the purpose. In a method of forming a functional protective film for an electronic display by solution casting, an coating apparatus is often provided, in addition to the machine of forming a film by solution casting, in order to conduct surface processing of the film such as formation of an undercoat layer, an antistatic layer, an antihalation layer or a protective layer. Each of the production steps will be simply described hereinafter which, however, is not limitative at all.

In preparing a cellulose acylate film by the solvent cast method, a prepared cellulose acylate solution (dope) is first cast onto a drum or a band to evaporate the solvent and form a film. The concentration of the dope before casting is preferably adjusted to 5 to 40% by mass in solid content. The surface of the drum or the band is preferably mirror finished. A method of casting the dope on a drum or a band having a surface temperature of 30° C. or lower is preferably employed. In particular, the temperature of the metal support is preferably in the range of from −10 to 20° C. Further, in the invention, methods described in JP-A-2000-301555, JP-A-2000-301558, JP-A-07-032391, JP-A-03-193316, JP-A-5-086212, JP-A-62-037113, JP-A-02-276607, JP-A-55-014201, JP-A-02-111511 and JP-A-02-208650 can be employed.

### [Multi-Layer Casting]

The cellulose acylate solution may be cast as a single layer onto a metal support of a smooth band or drum, or two or more cellulose acylate solutions may be cast thereonto. In the case of casting two or more cellulose acylate solutions, the solutions containing cellulose acylate are cast respectively through a plurality of casting slits provided at intervals in the metal support-traveling direction to thereby laminate the layers one over the other to form a film. For example, methods described in JP-A-61-158414, JP-A-1-122419 and JP-A-11-198285 can be applied. Also, it is possible to cast a cellulose acylate solution through two casting slits to form a film. This can be conducted according to methods described in JP-B-60-27562, JP-A-61-94724, JP-A-61-947245, JP-A-61-104813, JP-A-61-158413 and JP-A-6-134933. Further, there may be employed a cellulose acylate film-casting method described in JP-A-56-162617 wherein a flow of a cellulose acylate solution having a higher viscosity is surrounded by a cellulose acylate solution having a lower viscosity, and the cellulose acylate solution having a higher viscosity and the cellulose acylate solution having a lower viscosity are extruded at the same time. Further, an embodiment described in JP-A-61-94724 and JP-A-61-94725 wherein the outside solution contains a bad solvent of an alcohol component in a more content than in the inside solution is also a preferred embodiment. Still further, a film comprising a plurality of layers can be prepared by using two casting slits, peeling a film formed on the metal support by casting through the first casting slit, and conducting second casting onto the side of the film which side has been in contact with the metal support surface. For example, there is illustrated a method described in JP-B-44-20235. The plural cellulose acylate solutions to be cast may be the same solution or different cellulose acylate solutions, thus not being particularly limited. In order to impart functions to the plural cellulose acylate layers, it suffices to extrude cellulose acylate solutions respectively having corresponding functions through respective casting slits. It is also possible to cast the cellulose acylate solution simultaneously with other functional layers (e.g., an adhesive layer, a dye layer, an antistatic layer, an antihalation layer, a UV ray-absorbing layer and a polarizing layer).

With the conventional single layer solution, it has been necessary to extrude a cellulose acylate solution having a high concentration and a high viscosity in order to form a film having a necessary thickness. In such cases, stability of the cellulose acylate solution is liable to be deteriorated, and solids are formed to cause seeding trouble or deteriorate plane properties, thus many problems being involved. As a method for solving the problems, it has become possible extrude a plurality of solutions having a high viscosity at the same time onto a metal support by casting a plurality of cellulose acylate solutions through a casting slit. Thus, plane properties are improved to prepare a film having an excellent surface state and, in addition, use of a thick cellulose acylate solution serves to reduce a drying load and increase the speed of producing films.

In the case of co-casting, the thickness of the inside layer and the thickness of the outside layer are not particularly limited, but the thickness of the outside layer is preferably 10 to 50% of the thickness of the whole film, more preferably 2 to 30%. In the case of co-casting three or more layers, sum of the thickness of the layer in contact with the metal support and the thickness of the layer in contact with the air is defined as the thickness of the outside layer. In the case of co-casting, cellulose acylate solutions different from each other in concentration of an additive such as the plasticizer, the UV ray absorbent or the matt agent may be co-cast to form a cellulose acylate film of a laminate structure. For example, there can be formed a cellulose acylate film having a structure of skin layer/core layer/skin layer. For example, the matt agent can be incorporated in a more amount in the skin layer or can be incorporated only in the skin layer. The plasticizer and the UV ray absorbent can be incorporated in a more amount in the core layer than in the skin layer, or may be incorporated only in the core layer. It is also possible to change the kind of the plasticizer or the UV ray absorbent between the core layer and the skin layer. For example, at least one of a low volatile plasticizer and a UV ray absorbent can be incorporated in the skin layer, and a plasticizer having excellent plasticizing ability or a UV ray absorbent having an excellent UV ray-absorbing ability can be incorporated in the core layer. Further, it is a preferred embodiment to incorporate a peeling accelerator only in the skin layer on the metal support side. Still further, in order to gel the solution by cooling a metal support in the cooling drum method, it is also preferred to add a bad solvent of an alcohol in the skin layer in a larger amount than in the core layer. The skin layer and the core layer may be different from each other in Tg, with Tg of the core layer being preferably lower than Tg of the skin layer. Further, the viscosity of the cellulose acylate-containing solution upon casting for the skin layer may be different from that for the core layer. The viscosity of the solution for the skin layer is preferably smaller than that of the core layer, though the viscosity of the solution for the core layer may be smaller than that of the skin layer.

### [Casting Method]

As the casting method, there are illustrated a method of uniformly extruding a prepared dope onto a metal support through a pressure die, a doctor blade method of adjusting the thickness of the dope film once cast on a metal support by using a blade, and a reverse roll coater method of adjusting by means of reversely rotating rolls, with a pressure die method being preferred. The pressure die include a coat hunger type die and a T-die type die, with either of them being preferably used. In addition to the above-illustrated methods, various conventionally known methods of forming a film by casting a cellulose triacetate solution can be employed. The same effects as described in respective official gazettes can be obtained by selecting respective conditions in consideration of difference in boiling points of solvents to be used.

As the endlessly running metal support to be used in production of a cellulose acylate film of the invention, a drum whose surface is mirror finished by chromium plating or a stainless steel belt (also referred to as band) which is mirror finished by surface abrading is used. As to the number of the pressure dies to be used, one or more dies may be provided above the metal support, with one or two dies being preferred. In the case of providing two or more dies, the quantity of each dope to be cast may be variously changed according to each die, and the dope may be fed to individual dies at respective rates through plural accurately quantity-measuring gear pumps. The temperature of the cellulose acylate solution to be used for casting is preferably from −10 to 55° C., more preferably from 25 to 50° C. In this occasion, the solution temperature may be the same all through the steps, or may be different between the steps. In the case where the temperature is different, it suffices that the temperature is at a desired temperature immediately before casting.

### (Drying)

As to drying of a dope on the metal support to be conducted in the production of a cellulose acylate film, there are generally a method of applying hot blast from the surface side of the metal support (drum or belt), i.e., from the surface side of the web on the metal support, a method of applying hot blast from the back side of the drum or belt, and a back side-liquid-conducting method of bringing a temperature-controlled liquid into contact with the back side of the belt or drum which side is opposite to the dope-cast side to heat the drum or belt through heat conduction to thereby control the surface temperature, with the back side-liquid-conducting method being preferred. The surface temperature of the metal support before casting may be at any level as long as it is equal to or lower than the boiling point of the solvent used for the dope. However, in order to accelerate drying and remove fluidity on the metal support, the temperature is preferably set at a level lower than the boiling point of the solvent having the lowest boiling point among the solvents used by 1 to 10° C. Additionally, this does not apply in the case of cooling and peeling the cast dope without drying.

The Re value and the Rth value of the cellulose acylate film can be adjusted also by controlling the temperature of the metal support onto which a dope film is cast and the temperature and the amount of the drying blast applied to the dope film having been cast onto the metal support. In particular, the Rth value is strongly influenced by the drying conditions on the metal support. There results a decreased Rth value when the temperature of the metal support is increased or when the temperature or the amount of the drying blast to be applied to the dope film is increased, i.e., when the amount of heat to be given to the dope film is increased. On the other hand, there results an increased Rth value when the amount of heat is reduced. In particular, drying conditions in the first half of the period between the initiation of casting and the peeling of film largely influence the Rth value.

### (Stretching Treatment)

Retardation of the cellulose acylate film of the invention can be adjusted by stretching treatment. Further, there can be employed a method of actively stretching in the transverse direction which is described in, for example, JP-A-62-115035, JP-A-4-152125, JP-A-4-284211, JP-A-4-298310 and JP-A-11-48271. The produced film is stretched for obtaining a high in-plane retardation value of the cellulose acylate film.

Stretching of the film is performed at an ordinary temperature or under heating condition. The heating temperature is preferably from the apparent glass transition temperature Tg of the film upon stretching to Tg+20° C. Stretching of the film may be uniaxial stretching in the longitudinal or transverse direction, or may be simultaneous or successive biaxial stretching. Longitudinal stretching is performed with a stretching ratio of from 0.1 to 50%, preferably from 1 to 10%, particularly preferably from 2 to 5%. Transverse stretching is performed with a stretching ratio of from 3 to 100%, preferably from 10 to 50%, particularly preferably from 20 to 40%. As to birefringence it is preferred that the refractive index of a film in the width direction be larger than the refractive index in the longitudinal direction. Therefore, it is preferred for the stretching ratio in the transverse direction to be larger than the stretching ratio in the longitudinal direction. Also, the stretching treatment may be conducted during the film-forming process, or raw film wound after filming may be subjected to the stretching treatment. In the former case, stretching may be conducted in the state of a residual solvent being contained. Preferred stretching can be conducted when the content of the residual solvent is from 2 to 40% by mass.

In order to reduce unevenness with the in-plane slow axis in the width direction, it is preferred to provide a relaxation step after the transverse stretching. In the relaxation step, it is preferred to adjust the width of the film after relaxation to 100 to 70% (relaxation ratio: 0 to 30%) based on the width of the film before relaxation. The temperature in the relaxation step is preferably from the apparent glass transition temperature Tg-10 to Tg+20° C. The amount of residual solvent in the relaxation step is preferably controlled to be within the range of from 2 to 20%.

Here, the apparent Tg of the film in the stretching step was determined by sealing a film containing a residual solvent in an aluminum pan, heating in a differential scanning calorimeter (DSC) from 25° C. to 150° C. at a rate of 20° C./min, and determining an endothermic curve.

The thickness of the cellulose acylate film of the invention obtained after drying varies depending upon its end-use, and is preferably in the range of from 5 to 500 μm, more preferably from 20 to 300 μm, particularly preferably from 30 to 150 μm. As the film for optical use, particularly for VA mode liquid crystal display devices, the thickness is preferably from 40 to 110 μm. Adjustment of the film thickness can be conducted by adjusting the concentration of solids contained in the dope, slit-to-slit gap in the nozzle of the die, the pressure for extruding through the die and the running speed of the metal support so as to obtain a desired thickness. The width of the thus-obtained cellulose acylate film is preferably from 0.5 to 3 m, more preferably from 0.6 to 2.5 m, still more preferably from 0.8 to 2.2 m. As to the length of the film, it is preferred to wind with a length of from 100 to 10000 m per roll, more preferably from 500 to 7000 m, still more preferably from 1000 to 6000 m. Upon winding up the film, it is preferred to provide knurling on at least one edge with a width of preferably from 3 mm to 50 mm, more preferably from 5 mm to 30 mm, and a height of preferably from 0.5 to 500 μm, more preferably from 1 to 200 μm. This may be one-side press or both-side press.

### (Cyclic Olefin Type Polymer)

Further, as a protective film, a cyclic olefin type polymer can be used in place of cellulose acylate

### (Cyclic Polyolefin Type Resin)

According to the present invention, the term “cyclic polyolefin type resin” used herein means a polymer resin having a cyclic polyolefin structure. Further, according to the present invention, the “cyclic polyolefin type resin” is also referred to as a “cyclic polyolefin”.

Examples of polymer resins each containing a cyclic olefin structure to be used in the present invention include (1) norbornene type polymers, (2) monocyclic cyclic olefin polymers, (3) cyclic conjugate diene polymers, (4) vinyl alicyclic hydrocarbon polymers, and hydrogenated articles of polymers described in (1) to (4). The polymer resin preferably used in the present invention means an addition (co)polymer cyclic polyolefin having at least one type of repeating unit represented by the following formula (II) and, as need arises, an addition (co)polymer cyclic polyolefin further having at least one type of repeating unit represented by the following formula (I); and a ring-opening (co)polymer having at least one type of cyclic repeating unit represented by the formula (III) can also favorably be used:

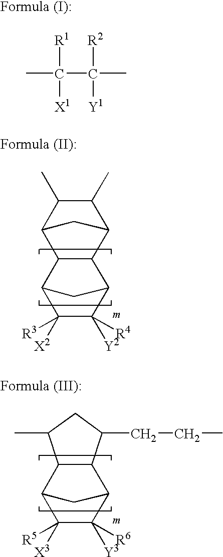

In the formula, m represents an integer of from 0 to 4;

R¹ to R⁶ each represent a hydrocarbon group having from 1 to 10 hydrogen atoms or carbon atoms;

X¹ to X³, and Y¹ to Y³ each represent a hydrogen atom, a hydrocarbon group having from 1 to 10 carbon atoms, a halogen atom, or a hydrocarbon group having from 1 to 10 carbon atoms substituted with a halogen atom, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ, —(CH₂)ₙW, or (—CO)₂O or (—CO)₂NR¹⁵ constituted by X¹ and Y¹, X² and Y², or X³ and Y³, wherein R¹¹, R¹², R¹³, R¹⁴ and R¹⁵ each represent a hydrogen atom, or a hydrocarbon group having from 1 to 20 carbon atoms; Z represents a hydrocarbon group or a hydrocarbon group substituted with a halogen; W represents SiR¹⁶ₚD₃₋ₚ (R¹⁶ represents a hydrocarbon group having from 1 to 10 carbon atoms; D represents a halogen atom, —OCOR¹⁶ or —OR¹⁶; and p represents an integer of from 0 to 3.); and

n represents an integer of from 0 to 10.

By introducing a functional group having a large polarity in a substituent of each of X¹ to X³, and Y¹ to Y³, retardation (Rth) in a thickness direction of an optical film is allowed to be larger, to thereby allow an exhibition property of retardation in plane (Re) to be larger. A film having a large exhibition property of the Re can be larger in an Re value by being stretched in a film-making process.

As for norbornene type addition (co)polymers, those described in JP-A No. 10-7732, JP-W No. 2002-504184, U.S. Patent No. 2004229157A1, or WO 2004/070463A1 can be used. They can be obtained by addition-polymerizing norbornene type polycyclic unsaturated compounds with each other. Further, as need arises, a norbornene type polycyclic unsaturated compound can be addition-polymerized with a conjugate diene such as ethylene, propylene, butene, butadiene or isoprene; a non-conjugate diene such as ethylydene norbornene; a linear diene compound such as acrylonitrile, acrylic acid, methacrylic acid, maleic anhydride, an acrylic ester, a methacrylic ester, maleimide, vinyl acetate, or vinyl chloride. As for these norbornene type addition (co)polymers, those available in the market can be used. Specifically, they are available from Mitsui Chemicals, Inc. under the trade name of “Apel”, while having different glass-transition temperatures (Tg), such as APL8008T (Tg: 70° C.), APL6013T (Tg: 125° C.), or APL6015T (Tg: 145° C.). Those in pellet form such as TOPAS8007, TOPAS6013, and TOPAS6015 are available from Polyplastics Co., Ltd. Further, Appear3000 is available from Promerus LLC.

As for hydrogenated norbornene type polymers, as described in JP-A Nos. 1-240517, 7-196736, 60-26024, 62-19801, and 2003-1159767, or 2004-309979, those produced by firstly addition-polymerizing or metathesis ring-opening polymerizing polycyclic unsaturated compounds and, then, hydrogenating the resultant polymers can be used. In the norbornene type polymers to be used in the present invention, R⁵ and R⁶ are each preferably a hydrogen atom or —CH₃, and X³ and Y³ are each preferably a hydrogen atom, Cl, or —COOCH₃ and other groups than these groups are appropriately selected. As for these norbornene type resins, those available in the market can be used. Specifically, they are available from JSR Corp. under the trade names of Arton G or Arton F, and from Zeon Corp. under the trade names of Zeonor ZF14, or ZF16, Zeonex 250 or Zeonex 280. These products can be used.

As for the polycyclic polyolefin type resin to be used in the present invention, a mass average molecular weight (Mw) thereof measured by using a gel permeation chromatography (GPC) is, in terms of polystyrene molecular weight, preferably in the range of from 5,000 to 1,000,000, more preferably in the range of from 10,000 to 500,000 and, still more preferably, in the range of from 50,000 to 300,000. Further, a molecular weight distribution (Mw/Mn; Mn denotes number average molecular weight measured by GPC) is preferably 10 or less, more preferably 5.0 or less and, still more preferably, 3.0 or less. Glass-transition temperature (Tg: being measured by DSC) is preferably in the range of from 50 to 350° C., more preferably in the range of from 80 to 330° C. and, still more preferably, in the range of from 100 to 300° C.

As for an optical compensatory sheet, an article which has two or more layers including a layer in which an optical anisotropic layer containing a liquid crystalline or non-liquid crystalline polymer layer is formed on a polymer film as a base material is also known. Specifically, an optical compensatory sheet (see JP-A No. 2004-4474) in which a polyimide layer is formed on a cellulose acetate film and, then, stretched, or an optical compensatory-sheet (see Japanese Patent No. 2660601, and JP-A No. 2003-287622) in which a cholesteric liquid crystalline layer is formed on a cellulose acetate film can be mentioned. These optical compensatory sheets each having two or more layers are formed by applying an optically anisotropic layer on a base material or by transferring a separately-formed anisotropic layer on the base material via a sticking layer.

When the optical anisotropic layer is formed on the base material by coating, in order to enhance adhesion between the optical anisotropic layer and the base material, an organic solvent which appropriately dissolves a surface of the base material is used as a solvent of the optical anisotropic layer. In this case, since an interface between the base material and the optical anisotropic layer comes not flat and is disturbed, scattering sometimes becomes larger.

Further, when the optical anisotropic layer is transferred on the base material via a sticking agent, scattering by the sticking layer or scattering by a minute crack generated in the optical anisotropic layer thus transferred may sometimes be generated.

Since such scattering of the optical anisotropic layer as described above allows light advancing in a direction inclined from a normal direction of a liquid crystal display device to be scattered in the normal direction of a panel (panel front face) in a black display state of the liquid crystal device, black luminance of the panel front face is increased. Namely, a contrast ratio of the panel front face is decreased.

When the optical compensatory sheet containing only one layer according to the present invention is used as a protective film of a polarizing plate, since such scattering as described above is not generated, the black luminance on the panel front face is low and the contrast ratio of the panel front face can be increased. Therefore, it is preferable to use the optical protective sheet containing only one (single) layer as the protective film of the polarizing plate.

In this specification, Re_{λ} and Rth_{λ} respectively represent in-plane retardation and retardation along the thickness. Re_{λ} can be measured by irradiating with an incident light of λnm in wavelength in the normal direction of the film using an automatic birefringence meter, for example, KOBRA 21ADH (manufactured by Ohji Measurement Co., Ltd.). Rth_{λ} can be calculated by an automatic birefringence meter, for example, KOBRA 21ADH, based on a retardation value measured by irradiating with an incident light of λnm with changing the incident angle from −50 to +50° every 10° taking the normal direction of the film as 0° and taking the slow axis in plane (determined by an automatic birefringence meter, for example, KOBRA 21ADH) as an inclination axis (rotation axis), and a retardation value measured by irradiating with an incident light of λnm in wavelength in the direction inclined at an angle of −40° from the normal line of the film with taking the slow axis in plane as an inclination axis (rotation axis), an assumed value of average refractive index, and an inputted film thickness. Here, as the assumed value of average refractive index, those described in a polymer handbook (John Wiley & Sons, Inc.) and catalogues of various optical films can be used. As to films whose average refractive index is unknown, it can be known by measuring with an Abbe's refractometer. Values of average refractive index of main films are illustrated below.

Cellulose acylate (1.48), cycloolefin polymer (1.52), polycarbonate (1.59), polymethyl methacrylate (1.49) and polystyrene (1.59).

nx, ny and nz are calculated by imputing these assumed average refractive index values and the film thickness into KOBRA 21ADH. Nz=(nx−nz)/(nx0ny) can further be calculated from the thus-calculated nx, ny and nz.

The unevenness with the Re₍₅₉₀₎ value along the full width is preferably within ±5 nm, more preferably within ±3 nm. The unevenness with the Rth₍₅₉₀₎ value is preferably within ±10 nm, more preferably within ±5 nm. Also, the unevenness with the Re value and the Rth value in the longitudinal direction is preferably within the unevenness in the width direction.

Fluctuation of the in-plane slow axis angle of the protective film disposed on a liquid crystal cell side used in the invention is preferably within the range of from −2° to +2°, more preferably from −1° to +1°, most preferably from −0.5° to +0.5° with respect to the standard direction of the roll film. Here, the standard direction means the longitudinal direction of a roll film when the protective film disposed on a liquid crystal cell side has been stretched in the longitudinal direction or the transverse direction of a roll film when stretched in the transverse direction.

Also, with the protective film disposed on a liquid crystal cell side used in the invention, the difference between Re value at 25° C. and 110% RH and Re value at 25° C. and 80% RH, ΔRe (=Re_{10%}-Re_{80%}), is preferably from 0 to 10 nm, the difference between Rth value at 25° C. and 10% RH and Rth value at 25° C. and 80% RH, ΔRth (=Rth_{10%}-Rth_{80%}), is preferably from 0 to 30 nm, in view of reducing change in tint with the elapse of time of a liquid crystal display device.

Further, the protective film disposed on a liquid crystal cell side used in the invention preferably has an equilibrium moisture content at 25° C. and 80% RH of 3.2% or less, in view of reducing change in tint with the elapse of time of a liquid crystal display device.

The moisture content is measured according to Karl Fischer's method using a moisture content-measuring apparatus and a sample-drying apparatus (“CA-03” and “V A-05”; both being manufactured by Mitsubishi Kagaku K.K.) and a 7 mm×35 mm protective film disposed on a liquid crystal cell side-sample. The amount (g) of water in the sample was divided by the mass (g) of the sample to calculate the moisture content.

Further, the protective film disposed on a liquid crystal cell side used in the invention preferably has a moisture permeability at 60° C., 95% RH and 24 hours (converted to a value for a film thickness of 80 μm) of less than 1800 g/m²·24 hr in view of reducing change in tint with the elapse of time of a liquid crystal display device.

The moisture permeability becomes smaller as the thickness is increased, whereas it becomes larger as the thickness is decreased. Thus, it is necessary to provide a standard film thickness which enables one to convert the thickness with respect to a sample with any thickness. The film thickness is converted according to the formula of (moisture permeability for the converted film thickness of 80 μm=moisture permeability found×film thickness found μm/80 μm).

As a method for measuring moisture permeability, the method described in Kobunshi No Bussei II, (Kobunshi Jikken Koza 4; Kyoritsu Shuppan), pp. 285-294: Measurement of the amount of permeated steam (method of measuring mass, method of using a thermometer, method of measuring vapor pressure, and method of measuring absorption amount) can be applied.

In the measurement of glass transition temperature, a 5 mm×30 mm protective film disposed on a liquid crystal cell side sample (non-stretched) was conditioned at 25° C. and 60% RH for 2 hours or longer, and measurement was conducted using a dynamic viscoelasticity measuring device (Vibron DVA-225 (manufactured by IT Keisoku Seigyo K.K.) with a grip-to-grip distance of 20 mm, a temperature-raising rate of 2° C./min, a measuring temperature range of from 30° C. to 200° C. and a frequency of 1 Hz. The data were plotted, with storage modulus of elasticity as logarithmic ordinate and temperature (° C.) as linear abscissa. A temperature at which a sharp reduction in storage modulus of elasticity observed when the film sample moves from a solid region to a glass transition region is determined as follows. That is, a line 1 is drawn in the solid region, and a line 2 is drawn in the glass transition region, thus an intersection point of lines 1 and 2 being found which corresponds to the temperature at which the storage elasticity of modulus sharply decreases upon increasing temperature and the film initiates to soften and at which the film initiates to migrate to the glass transition region. Thus, the temperature is taken as the glass transition temperature Tg (dynamic viscoelasticity).

In measuring modulus of elasticity, a 10 mm×150 mm protective film disposed on a liquid crystal cell side used in the invention was conditioned at 25° C. and 60% RH for 2 hours, and measurement was conducted with a chuck-to-chuck distance of 100 mm at a temperature of 25° C. with a drawing speed of 10 mm/min using a tensile tester (Strograph-R2 manufactured by Toyo Seiki).

The coefficient of expansion due to absorption of moisture was determined from the dimension value of a film having been left at 25° C. and 80% RH for 2 hours or more, L80, measured by means of a pin gauge and the dimension value of a film having been left at 25° C. and 10% RH for 2 hours or more, L10, measured by means of a pin gauge according to the following numerical formula:

L10−L80)/(80% RH−10% RH)×1000000

The protective film disposed on a liquid crystal cell side used in the invention preferably has a haze in the range of from 0.01% to 2%. Here, the haze can be measured in the following manner.

Haze of a 40 mm×80 mm protective film disposed on a liquid crystal cell side sample of the invention was measured at; 25° C. and 60% RH according to JIS K-6714 using a haze meter (HGM-2DP; manufactured by SUGA TEST INSTRUMENTS CO., LTD.).

Further, the protective film disposed on a liquid crystal cell side used in the invention preferably undergoes a mass change in the range of from 0 to 5% by mass when allowed to stand at 80° C. and 90% RH for 48 hours.

Still further, the protective film disposed on a liquid crystal cell side used in the invention preferably undergoes a small dimensional change in the range of from 0 to 5% when allowed to stand at 60° C. and 95% RH and when allowed to stand at 90° C. and 5% RH for 24 hours.

The optical elasticity coefficient is preferably 50×10⁻¹³ cm²/dyne (5×10⁻¹¹ m²/N) or less in view of reducing change in tint with the elapse of time of a liquid crystal display device.

As to a specific measuring method, a tensile stress was applied to a 10 mm×100 mm protective film disposed on a liquid crystal cell side sample in the longitudinal direction, and retardation of the film was measured thereupon using an elipsometer (M150; manufactured by Nihon Bunko K.K.). The optical elasticity coefficient was calculated from the variation amount of retardation for the stress.

### (Polarizing Plate)

Next, the polarizing plate of the invention will be described below.

The polarizing plate of the invention is a polarizing plate wherein at least one sheet of the above-mentioned cellulose acylate film or the cyclic polyolefin film of the invention is used as a protective film for a polarizer. In addition, the protective film may be a film of cyclic polyolefin resin, however, examples using a cellulose acetate film as representative of the protective film will be described hereafter.

A polarizing plate usually comprises a polarizer and two transparent protective films disposed on each side of the polarizer. In the invention, the cellulose acylate film used in the invention is used as at least one of the protective films. As the other protective film, either the cellulose acylate film used in the invention or a common cellulose acylate film may be used. Curling of the polarizing plate can be controlled by adjusting the relation among the thickness, modulus of elasticity and coefficient of expansion due to absorption of moisture of the protective film on the liquid crystal cell side and the protective film on the opposite side to the liquid crystal cell.

As the polarizer for the polarizing film, there are illustrated an iodine-containing polarizer and a dye-containing polarizer. The iodine-containing polarizer and the dye-containing polarizer are generally produced by using a polyvinyl alcohol series film. In the case of using the cellulose acylate film used in the invention as a protective film in a polarizing plate, the method for preparing the polarizing plate is not particularly limited, and the polarizing plate can be prepared according to commonly employed methods. For example, there is illustrated a method of alkali-treating the resulting cellulose acylate film and laminating the film on both sides of a polarizer prepared by dip-stretching a polyvinyl alcohol film in an iodine solution using an aqueous solution of a completely saponified polyvinyl alcohol. An easily sticking treatment may be conducted as described in JP-A-6-94915 and JP-A-6-118232 in place of the alkali treatment. As the adhesive for sticking the treated surface of the protective film and the polarizer to each other, there are illustrated, for example, polyvinyl alcohol series adhesives such as polyvinyl alcohol and polyvinyl butyral and vinyl series latexes such as butyl acrylate. The polarizing plate is constituted by a polarizer and protective films protecting both sides of the polarizer. Further, a protect film may be laminated on one side of the polarizing plate, and a separate film may be laminated on the opposite side to constitute a polarizing plate.

The protect film and the separate film are used for protecting the polarizing plate upon shipping the polarizing plate and upon checking the product. In this occasion, the protect film is used for the purpose of protecting the surface of the polarizing plate, and is applied to the opposite side of the polarizing plate to the side to be laminated onto a liquid cell. Also, the separate film is used for the purpose of covering the adhesive layer to be used for laminating the polarizing plate to the liquid crystal cell, and is applied to the side of the polarizing plate to be laminated onto a liquid cell.

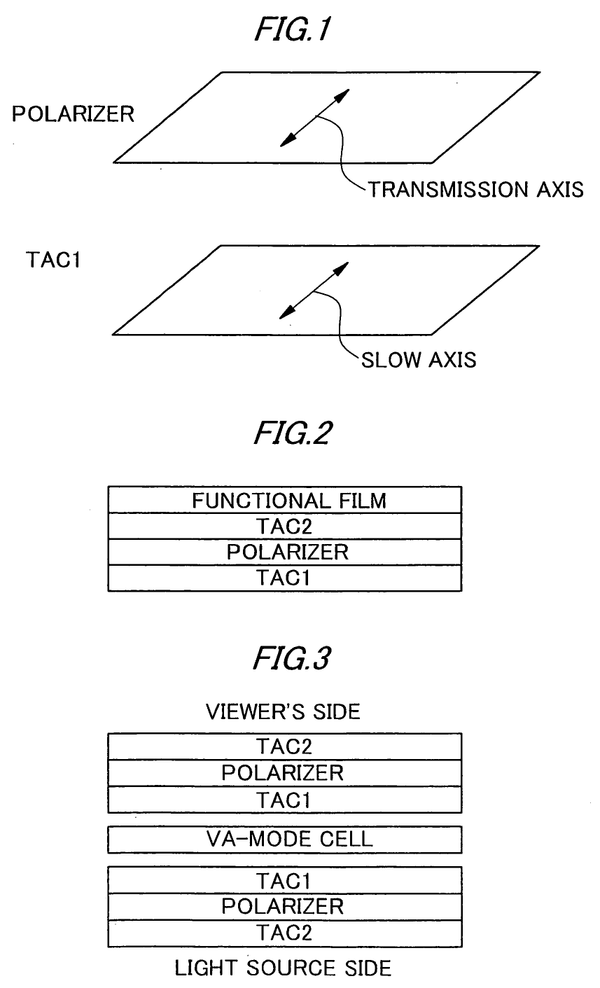

As to the manner of laminating the cellulose acylate film of the invention onto the polarizer, it is preferred to laminate so that the transmission axis of the polarizer coincides with the slow axis of the cellulose acylate film of the invention (TAC in FIG. 1) as shown in the schematic diagram FIG. 1 showing the manner of laminating the cellulose acylate film. As described above, the cellulose acetate protective film can be replaced with a protective film of the cyclic polyolefin resin. In this case, it is preferred to laminate with the polarizer by conducting a surface treatment described below.

Additionally, with a polarizing plate prepared under a cross-Nicol position, if the slow axis of the cellulose acylate film of the invention crosses at right angles with the absorption axis of the polarizer (axis crossing at right angles with the transmission axis) with an accuracy larger than 1°, there arises leakage of light due to deterioration of polarizing performance under a cross-Nicol position, which leads to failure to obtain a sufficient black level or a sufficient contrast when combined with a liquid crystal cell. Thus, deviation between the direction of the slow axis of the cellulose film of the invention and the direction of the transmission axis of the polarizing plate is preferably within 1°, more preferably within 0.5°.

The hue a^{*} and the hue b^{*} of the polarizing plate of the invention under a cross-Nicol position be adjusted to −1.0≦a^{*}≦2.0 and −1.0≦b^{*}≦2.0, more preferably −0.5≦a^{*}≦1.5 and −0.5≦b^{*}≦1.5, respectively, in order to control the tint of a liquid crystal display upon black display within an appropriate range.

The hue of the polarizing plate can be controlled within the above-described range by optimizing the conditions for preparing the polarizer.

The hues a^{*} and b^{*} of the polarizing plate are determined by measuring a spectral transmittance of the polarizing plate in the visible region by means of a spectrophotometer, multiplying the obtained spectral transmittance by color matching function to determine the three excitation values of X, Y and Z, and determining based on the definition of L^{*}a^{*}b^{*} color space by CIE1976. Detailed descriptions are given in Irosaigen Kogaku No Kiso (K.K. Koronasha).

Specifically, transmittance was measured under the following measuring conditions using a spectrophotometer UV-3100 (manufactured by Shimadzu Corp.) in the color-measuring mode to calculate the hues of the polarizing plate.

Wavelength range for measurement: 780-380 nm
Scanning speed: middle speed; Slit width: 2.0 nm
Sampling pitch: 1.0 nm
Light source: light source C; Viewing angle; 2°

Here, two polarizing plates were disposed with the protective film on the cell side of one polarizing plate facing the protective film on the cell side of the other polarizing plate and the transmission axes of the two polarizing plates crossing at right angles with each other, so that the transmission axis of the polarizing plate was at an angle of 45° with respect to the normal direction of a sample chamber of the spectrophotometer (direction of grating grooves).

The single plate transmittance, parallel transmittance and orthogonal transmittance of a polarizing plate can be measured by means of a spectrophotometer in the same manner as in the measurement of hues of a polarizing plate. Specifically, transmittance is measured under the following conditions using the spectrophotometer UV-3100 (manufactured by Shimadzu Corp.).

Wavelength range for measurement: 780-380 nm
Scanning speed: middle speed; Slit width: 2.0 nm
Sampling pitch: 1.0 nm

Here, the transmission axis of the polarizing plate was disposed at an angle of 45° with respect to the normal direction of a sample chamber of the spectrophotometer (direction of grating grooves).

### [Surface Treatment]

The cellulose acylate film or the cyclic polyolefin film to be used in the invention can be, in some cases, subjected to surface treatment to improve adhesion between the cellulose acylate film or the cyclic polyolefin film and various functional layers (e.g., an undercoat layer and a back layer). As the surface treatment, there can be employed a glow discharge treatment, a UV ray irradiation treatment, a corona treatment, a flame treatment or a treatment with an acid or an alkali. The glow discharge treatment may be a low-temperature plasma treatment conducted under a 10⁻³ to 20 Torr low-pressure gas, or may be a plasma treatment under the atmospheric pressure. Plasma-forming gases mean gases forming plasma under the above-described conditions and include argon, helium, neon, krypton, xenon, nitrogen, carbon dioxide, flons such as tetrafluoromethane, and a mixture thereof. These are described in detail in Hatsumei Kyokai Kokai Giho, Kogi No. 2001-1745 (published on 15, Mar. 2001 by Hatsumei Kyokai), pp. 30-32. Additionally, a plasma treatment under the atmospheric pressure, which has been noted in recent years, uses an irradiation energy of from 20 to 500 Kgy under 10 to 1,000 Kev, more preferably from 20 to 300 Kgy under 30 to 500 Kev. Of these treatments, an alkali saponification treatment is particularly preferred, which is extremely effective as a surface treatment for the cellulose acylate film.

The alkali saponification treatment is preferably conducted according to a method of directly dipping a cellulose acylate film into a tank of a saponification solution or a method of coating the saponification solution onto a cellulose acylate film. Examples of the coating method include a dip coating method, a curtain coating method, an extrusion coating method, a bar coating method and an E-type coating method.

As to a solvent for the coating solution of alkali saponification treatment, it is preferred to select a solvent which has good wetting properties and can keep the surface state in a good state-without forming unevenness on the surface of the cellulose acylate film. Specifically, alcohol series solvents are preferred, with isopropyl alcohol being particularly preferred. Also, an aqueous solution of a surfactant can be used as a solvent. As the alkali for the coating solution of alkiali saponification, alkalis which dissolve in the above-mentioned solvents are preferred, with KOH and NaOH being more preferred. The pH of the coating solution of saponification is preferably 10 or more, more preferably 12 or more. As to the reaction conditions upon alkali saponification, the reaction is conducted preferably at room temperature for 1 second to 3 minutes, more preferably for 5 seconds to 5 minutes, particularly preferably for 20 seconds to 3 minutes. After the alkali saponification reaction, the surface having been coated with the saponification solution is preferably washed with water, or washed with successive, an acid and water.

The polarizing plate of the invention preferably has at least one of a hard coat layer, an anti-glare layer and an anti-reflection layeron the surface of a protective film on the other side of the polarizing plate. That is, as is shown in FIG. 2 which schematically shows a cross-sectional structure of the polarizing plate of the invention, upon use of the polarizing plate in a liquid crystal display device, it is preferred to provide a functional film such as an anti-reflection film on the protective film (TAC2) to be disposed on the opposite side to the liquid crystal cell. As such functional film, at least one of a hard coat layer, an anti-glare layer and an anti-reflection layer is preferably provided. Additionally, the layers are not necessarily be provided as separate layers and, for example, the anti-reflection layer or the hard coat layer may also have the anti-glare function and may be used as an anti-glare, anti-reflection layer.

### [Anti-Reflection Layer]

In the invention, an anti-reflection layer comprising at least a light-scattering layer and a low-refractive-index layer laminated in this order or an anti-reflection layer comprising a middle-refractive-index layer, a high-refractive-index layer and a low-refractive-index layer laminated in this order is preferably provided on the protective film of the polarizing plate. Preferred embodiments thereof will be described below. Additionally, in the former constitution, the specular surface reflectance becomes 1% or more, and the film is called Low Reflection (LR) film. In the latter constitution, the specular surface reflectance can be reduced to 0.5% or less, and the film is called Anti Reflection (AR) film.

A preferred embodiment of an anti-reflection film (LR film) formed on the protective film of the polarizing plate by providing a light-scattering layer and a low-refractive-index layer will be described below.

The light-scattering layer preferably contains matt particles dispersed therein. The refractive index of other materials than the matt particles in the light scattering layer is preferably in the range of from 1.50 to 2.00, and the refractive index of the low-refractive-index layer is preferably in the range of from 1.20 to 1.49. In the invention, the light-scattering layer has both anti-glare properties and hard coat properties, and may comprise a single layer or a plurality of layers, for example, 2 to 4 layers.

The surface profile of the anti-reflection layer is preferably designed so that the center-line roughness Ra is between 0.08 and 0.40 μm, the 10-point average roughness Rz is 10 times as much as Ra or less than that, the average peak-valley distance Sm is between 1 and 100 μm, the standard deviation of the height of peak from the deepest valley is 0.5 μm or less, the standard deviation of the average peak-valley distance Sm taking the center line as a standard is 20 μm or less, and the plane with an inclined angle of 0 to 5° accounts for 10% or more, which serves to obtain sufficient anti-glare properties and uniform matt appearance when viewed with the eye.

When the color tint of a reflected light under a light source C is −2 to 2 in a^{*} value and −3 to 3 in b^{*} value and the ratio of the minimum reflectance to the maximum reflectance is from 0.5 to 0.99 in the range between 380 nm and 780 nm, the reflected light has a neutral color tint, thus such layer being preferred. Further, when b^{*} value of the transmission light under the light source C is adjusted to 0 to 3, a yellowish tint upon displaying white color on a display device using the film can be reduced, thus such layer being preferred. Still further, when the standard deviation of luminance distribution measured on the film with inserting a 120 μm×40 μm lattice between a plane light source and the anti-reflection film is 20 or less, dazzling can be reduced in the case of applying the film of the invention to a highly fine panel, thus such layer being preferred.

The anti-reflection layer to be used in the invention preferably has optical characteristics of 2.5 or less in secular surface reflectance, 90% or more in transmittance and 70% or less in 60° surface gloss, which serve to suppress reflection of external light and improve viewability. In particular, the specular surface reflectance is more preferably 1% or less, most preferably 0.5% or less. The anti-reflection layer preferably has a haze of from 20% to 50%, an internal haze/total haze ratio of from 0.3 to 1, a reduction in haze value from formation of the light-scattering layer to formation of the low-refractive-index layer of within 15%, a transmitted image distinctness in an optical comb width of 0.5 mm of from 20% to 50% and a transmission ratio of a vertical transmission light/a light inclined 2° from the vertical direction of from 1.5 to 5.0, which serves to prevent dazzling on a highly fine LCD panel and reduce unsharpness of letters.

### (Low-Refractive-Index Layer)

The low-refractive-index layer to be used in the invention has a refractivity of preferably from 1.20 to 1.49, more preferably from 1.30 to 1.44. Further, the low-refractive-index layer preferably satisfies the following numerical formula (XVII) in view of reducing reflectance:

(m/4)×0.7<nldl<(m/4)×1.3 numerical formula (XVII)

In the numerical formula, m represents a positive odd number, nl represents a reflectance of the low-refractive-index layer, and dl represents the thickness (nm) of the low-refractive-index layer. Also, λ represents a wavelength and is a value in the range of from 500 to 550 nm.

Materials forming the low-refractive-index layer are described below.

The low-refractive-index layer preferably contains a fluorine-containing polymer as a low-refractive binder. As the fluorine-containing polymer, fluorine-containing polymers having a kinetic friction coefficient of from 0.03 to 0.20, a contact angle to water of from 90 to 120° and a pure water-dropping angle of 70° or less and capable of cross-linking by heat or ionizing radiation are preferred. In the case of mounting the polarizing plate of the invention on an image display device, a smaller peeling force required for peeling a commercially available adhesive tape provides an easier peeling of a seal or a memo adhesively applied thereto, thus being preferred. Such peeling force is preferably 500 gf or less, more preferably 300 gf (2.94N) or less, most preferably 100 gf (0.98N) or less, when measured by means of a tensile tester. A higher surface hardness measured by means of a microhardness tester provides a less scratchable surface, and the surface hardness is preferably 0.3 GPa or more, more preferably 0.5 GPa or more.

As the fluorine-containing polymer to be used for the low-refractive-index layer, there are illustrated a hydrolyzate and a dehydration condensate of a perfluoroalkyl group-containing silane compound {e.g., (heptadecafluoro-1,1,2,2-tetrahydrodecyl}-triethoxysilane} and a fluorine-containing copolymer containing a fluorine-containing monomer unit and a constituting unit for imparting cross-linking reactivity.

Specific examples of the fluorine-containing monomer include fluoroolefines (e.g., fluoroethylene, vinylidene fluoride, tetrafluoroethylene, perfluorooxtylethylene, hexafluoropropylene and perfluoro-2,2-dimethyl-1,3-dioxol), partially or completely fluorinated alkyl ester derivatives of (meth)acrylic acid [e.g., “Viscoat 6FM” (manufactured by Osaka Organic Chemical Industry Ltd.) and “M-2020” (manufactured by Daikin Kogyo K.K.)] and partially or completely fluorinated vinyl ethers, with perfluoroolefins being preferred. In view of refractive index, solubility, transparency and availability, hexafluoropropylene is particularly preferred.

As a constituting unit for imparting cross-linking reactivity, there are illustrated a constituting unit obtained by polymerization of a monomer having a self-cross-linking functional group within the molecule such as glycidyl (meth)acrylate or glycidyl vinyl ether, a constituting unit obtained by polymerization of a monomer having a carboxyl group, a hydroxyl group, an amino group or a sulfo group {e.g., (meth)acrylic acid, methylol (meth)acrylate, hydroxyalkyl (meth)acrylate, allyl acrylate, hydroxyethyl vinyl ether, hydroxybutyl vinyl ether, maleic acid or a crotonic acid} and a constituting unit obtained by introducing a cross-linkable group such as a (meth)acryloyl group into the above-mentioned constituting unit by a high-molecular reaction (for example, introduction being conducted by acting acryloyl chloride on hydroxyl group).

In view of solubility in a solvent and transparency of the film, a fluorine atom-free monomer can properly be copolymerized in addition to the fluorine-containing monomer unit and the constituting units for imparting the cross-linking reactivity. The monomer unit to be used in combination is not particularly limited, and examples thereof include olefins (e.g., ethylene, propylene, isoprene, vinyl chloride and vinylidene chloride), acrylates (e.g., methyl acrylate, ethyl acrylate and 2-ethylhexyl acrylate), methacrylates (e.g., methyl methacrylate, ethyl methacrylate, butyl methacrylate and ethylene glycol dimethacrylate), styrene derivatives (e.g., styrene, divinylbenzene, vinyltoluene and α-methylstyrene), vinyl ethers (e.g., methyl vinyl ether, ethyl vinyl ether and cyclohexyl vinyl ether), vinyl esters (e.g., vinyl acetate, vinyl propionate and vinyl cinnamate), acrylamides (e.g., N-t-butylacrylamide and N-cyclohexylacrylamide), methacrylamides and acrylonitrile derivatives.

A curing agent may properly be used in combination with the above-described polymers as described in JP-A-10-25388 and JP-A-10-147739.

### (Light-Scattering Layer)

A light-scattering layer is formed for the purpose of imparting to the film light-scattering properties by at least either of surface scattering and internal scattering and hard coat properties for improving scratching resistance of the film. Therefore, it is formed by incorporating a binder for imparting hard coat properties, matt particles for imparting light-scattering properties and, as needed, an inorganic filler for increasing refractive index, preventing contraction due to cross-linking and increasing strength. The thus-provided light-scattering layer also functions as an anti-glare layer, thus the polarizing plate having an anti-glare layer at the same time.

The thickness of the light-scattering layer is preferably from 1 to 10 μm, more preferably from 1.2 to 6 μm for the purpose of imparting hard coat properties. When the thickness of the light-scattering layer is too small, there results insufficient hard properties whereas, when the thickness is too large, there results a deteriorated curling resistance or a deteriorated brittleness, thus working adaptability becoming insufficient.

As the binder for the light-scattering layer, polymers having a saturated hydrocarbon chain or a polyether chain as a main chain are preferred, with polymers having a saturated hydrocarbon chain as a main chain being more preferred. Also, the binder polymer preferably has a cross-linked structure. As the binder polymer having a saturated hydrocarbon chain as a main chain, polymers of an ethylenically unsaturated monomer are preferred. As the binder polymer having a saturated hydrocarbon chain as a main chain and having a cross-linked structure, (co)polymers of a monomer having two or more ethylenically unsaturated groups are preferred. In order to impart a high refractive index to the binder polymer, it is also possible to select a monomer having within its structure an aromatic ring or at least one atom selected from among a halogen atom other than fluorine atom, a sulfur atom, a phosphorus atom and a nitrogen atom.

As the monomer having two or more ethylenically unsaturated groups, there are illustrated esters between a polyhydric alcohol and (meth)acrylic acid {e.g., ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexameth}acrylate, 1,2,3-cyclohexane tetramethacrylate, polyurethane polyacrylate and poloyester polyacrylate}, ethylene oxide-modified products of the above-described esters, vinylbenzene and the derivatives thereof (e.g., 1,4-divinylbenzene, 4-vinylbenzoic acid-2-acryloylethyl ester and 1,4-divinylcyclohexanone), vinylsulfones (e.g., divinylsulfone), acrylamides (e.g., methylenebisacrylamide) and methacrylamides. These monomers may be used in combination of two or more thereof.

Specific examples of the highly refractive monomer include bis(4-methacryloylthiophenyl)sulfide, vinylnaphthalene, vinylphenylsulfide and 4-methacryloxyphenyl-4′-methoxyphenyl thioether. These monomers may also be used in combination of two or more thereof.

Polymerization of these monomers having an ethylenically unsaturated group or groups can be conducted by irradiating with ionizing radiation or by heating in the presence of a photo radical initiator or a heat radical initiator. Therefore, the anti-reflection film can be formed by preparing a coating solution containing the ethylenically unsaturated group-having monomer, the photo radical initiator or heat radical initiator, matt particles and an inorganic filler and, after coating the coating solution on the protective film, conducting polymerization reaction by polymerization reaction caused by ionizing radiation or by heat. As the photo radical initiator, known ones may be used.

The polymer having a polyether as a main chain is preferably a ring-opening polymerization product of a multi-functional epoxy compound. The ring-opening polymerization of the multi-functional epoxy compound can be conducted by irradiating with ionizing radiation or by heating in the presence of a photo acid generator or a heat acid generator. Therefore, the anti-reflection film can be formed by preparing a coating solution containing the multi-functional epoxy compound, the photo acid generator or heat acid generator, matt particles and an inorganic filler and, after coating the coating solution on the protective film, conducting polymerization reaction by polymerization reaction caused by ionizing radiation or by heat to cure.

It is also possible to use a monomer having a cross-linkable functional group in place of or in addition to the monomer having two or more ethylenically unsaturated groups to thereby, introduce the cross-linkable functional group into the polymer and introduce a cross-linked structure into the binder polymer through reaction of the cross-linkable functional group.

Examples of the cross-linkable functional group include an isocyanato group, an epoxy group, an aziridine group, an oxazoline group, an aldehydro group, a carbonyl group, a hydrazon group, a carboxyl group, a methylol group and an active methylene group. Vinylsulfonic acid, acid anhydrides, cyanoacrylate derivatives, melamine, etherified methylol, esters, urethane and metal alkoxides such as tetramethoxysilane can also be utilized as the monomer for introducing the cross-linked structure. It is also possible to use a functional group which shows cross-linkability as a result of decomposition reaction such as a blocked isocyanato group. That is, in the invention, the cross-linkable functional group may be a group which does not immediately show its cross-linking ability but shows it as a result of its decomposition.

These binder polymers having the cross-linkable functional groups can form a cross-linked structure when heated after being coated.

Matt particles having an average particle size of from 1 to 10 μm, preferably from 1.5 to 7.0 μm, larger than the filler particles, are incorporated in the light-scattering layer for the purpose of imparting anti-glare properties. Preferred specific examples of the matt particles include particles of inorganic compounds such as silica particles and TiO2 particles; and resin particles such as acryl particles, cross-linked acryl particles, polystyrene particles, cross-linked polystyrene particles, melamine resin particles and benzoguanamine resin particles. Of these, cross-linked styrene particles, cross-linked acryl particles, cross-linked acrylstyrene particles and silica particles are preferred. As to the shape of matt particles, either of spherical particles and amorphous particles may be used.

Further, as to particle size distribution of the matt particles, a monodisperse distribution is most preferred, and the particle sizes of individual particles are preferably as near as possible to each other. For example, the proportion of coarse particles which are defined as particles having a particle size larger then the average particle size by 20% or more is preferably 1% or less in number based on the number of the total particles, more preferably 0.1% or less, still more preferably 0.01% or less. Matt particles having such particle size distribution can be obtained by classification after usual synthesis reaction. A matt agent having more preferred distribution can be obtained by increasing the number of times of classification or by intensifying the degree of classification.

The matt particles are incorporated in the light-scattering layer so that the amount of matt particles in the formed light-scattering layer becomes 10 to 1,000 mg/m², more preferably 100 to 700 mg/m². The particle size distribution of matt particles is measured according to the Coulter counter method, and the measured distribution is converted to particle number distribution.

In order to increase the refractive index of the layer, the light-scattering layer preferably contains an inorganic filler, in addition to the matt particles, which comprises at least an oxide of a metal selected from among titanium, zirconium, aluminum, indium, zinc, tin and antimony and has an average particle size of 0.2 μm or less, preferably 0.1 μm or less, more preferably 0.06 μm or less.

To the contrary, in order to increase difference in refractive index from the matt particles, it is also preferred to use a silicon oxide in a light-scattering layer using highly refractive matt particles for the purpose of keeping the refractive index of the layer at a low level. As to preferred particle size, the same applies as with the inorganic filler.

Specific examples of the inorganic filler to be used in the light-scattering layer include TiO₂, ZrO₂, Al₂O₃, In₂O₃, ZnO, SnO₂, Sb₂O₃, ITO and SiO₂, with TiO₂ and ZrO₂ being particularly preferred in view of increasing refractive index. The surface of the inorganic filler may preferably be subjected to silane coupling treatment or titanium coupling treatment. A surface treating agent having a functional group capable of reacting with the binder species and the filler surface is preferably used.

The addition amount of the inorganic filler is preferably from 10 to 90%, more preferably from 20 to 80%, particularly preferably from 30 to 75%, based on the total mass of the light-scattering layer.

Additionally, since such filler has a particle size enough smaller than wavelength of light, it does not cause scattering, and the dispersion wherein the filler is dispersed in the binder polymer behaves as an optically uniform substance.

The bulk refractive index of the mixture of the binder and the inorganic filler of the light-scattering layer is preferably from 1.50 to 2.00, more preferably from 1.51 to 1.80. In order to adjust the refractive index to the above-mentioned range, it suffices to properly select the kinds and amounts of the binder and the inorganic filler. Proper selection can be easily known previously through experiments.

The coating composition for forming the light-scattering layer contains a surfactant of either fluorine-containing type or silicone type or both of them particularly in order to ensure surface uniformity free of coating unevenness, drying unevenness and spot defect. In particular, the fluorine-containing surfactant is preferably used because it exhibits the effect of removing surface troubles of the anti-reflection film of the invention such as coating unevenness, drying unevenness and spot defect when used in a smaller amount. The purpose is to enhance productivity by imparting high-speed coating adaptability while enhancing surface.

Next, an anti-reflection layer formed by laminating a middle-refractive-index layer, a high-refractive-index layer and a low-refractive-index layer in this order on the protective film (AR film) will be described below.

The anti-reflection layer formed on the protective layer and having a layered structure wherein at least a middle-refractive-index layer, a high-refractive-index layer and a low-refractive-index layer (outermost layer) are provided in this order is designed to have the refractive indexes satisfying the following relation:

refractive index of the high-refractive-index layer>refractive index of the middle-refractive-index layer>the refractive index of the protective film>the refractive index of the low-refractive-index layer.

It is also possible to provide a hard coat layer between the protective film and the middle-refractive-index layer. Further, the AR film may comprise a middle-refractive-index layer, a hard coat layer, a high-refractive-index layer and a low-refractive-index layer. There can be illustrated, for example, anti-reflection layers described in JP-A-8-122504, JP-A-8-110401, JP-A-10-300902, JP-A-2002-243906 and JP-A-2000-111706.

Further, each layer may have other function. For example, there are illustrated a stain-proof low-refractive-index layer and an antistatic high-refractive-index layer (e.g., JP-A-10-206603 and JP-A-2002-243906).

The haze of the anti-reflection layer is preferably 5% or less, more preferably 3% or less. Also, the surface strength of the film is preferably H or more, more preferably 2H or more, most preferably 3H or more, in the pencil hardness test according to JIS K-5400. (Hihg-refractive-index layer and middle-refractive-index layer)

The layer having a high refractive index in the anti-reflection film comprises a cured film containing at least highly refractive inorganic compound fine particles of 100 nm or less in average particle size and a matrix binder.

The highly refractive inorganic compound fine particles include inorganic compounds of 1.65 or more in refractive index, with those of 1.9 or more in refractive index being more preferred. For example, there are illustrated oxides of Ti, Zn, Sb, Sn, Zr, Ce, Ta, La and In and composite oxides containing these metal atoms.

In order to obtain such fine particles, there are illustrated a technique of treating the particle surface with a surface treating agent (e.g., silane coupling agents described in JP-A-11-295503, JP-A-11-153703 and JP-A-2000-9908; anionic compounds or organometallic coupling agents described in JP-A-2001-310432), a technique of forming a core-shell structure wherein highly refractive particles form a core (JP-A-2001-166104), and a technique of using a specific dispersing agent in combination (e.g., JP-A-11-153703, U.S. Pat. No. 6,210,858 and JP-A-2002-277609).

As the material for forming the matrix, there are illustrated conventionally known thermoplastic resins and curable resin films.

As more preferred materials, there are illustrated at least one composition selected from among a composition containing a multi-functional compound having 2 or more polymerizable groups (at least either of radical-polymerizable and cation-polymerizable groups), a composition containing an organometallic compound having a hydrolysable group, and a composition containing the partial condensate thereof. For example, there are illustrated those compounds which are described in JP-A-2000-47004, JP-A-2001-315242, JP-A-2001-31871 and JP-A-2001-296401.

Also, a curable film obtained from a colloidal metal oxide obtained from a hydrolysis condensate of a metal alkoxide and a metal alkoxide composition are preferred, which is described in, for example, JP-A-2001-293818.

The refractive index of the high-refractive-index layer is preferably from 1.70 to 2.20. The thickness of the high-refractive-index layer is preferably from 5 nm to 10 μm, more preferably from 10 nm to 1 μm.

The refractive index of the middle-refractive-index layer is adjusted to be a value between the refractive index of the low-refractive-index layer and the high-refractive-index layer. The refractive index of the middle-refractive-index layer is preferably from 1.50 to 1.70. Also, the thickness is preferably from 5 nm to 10 μm, more preferably from 10 nm to 1 μm.

### (Low-Refractive-Index Layer)

The low-refractive-index layer is laminated in order on the high-refractive-index layer. The refractive index of the low-refractive-index layer is preferably from 1.20 to 1.55, more preferably from 1.30 to 1.50.

The low-refractive-index layer is preferably constituted as the outermost layer having anti-scratching and stain-proof properties. As a means to largely improve scratching resistance, it is effective to impart sliding properties to the surface, and conventionally known means such as introduction of silicone or fluorine can be applied.

As the fluorine-containing compound, those compounds are preferred which contain fluorine atom in a content of from 35 to 80% by mass and have a cross-linkable or polymerizable functional group. For example, there are illustrated compounds described in JP-A-9-222503, paragraphs [0018] to [0026], JP-A-11-38202, paragraphs [0019] to [0030], JP-A-2001-40284, paragraphs [0027] to [0028] and JP-A-2000-2841-2.

The refractive index of the fluorine-containing compound is preferably from 1.35 to 1.50, more preferably from 1.36 to 1.47.

As the silicone compound, compounds having a polysiloxane structure and having a curable functional group or a polymerizable functional group in the high molecular chain which functions to form a cross-linked structure in the film are preferred. For example, there are illustrated a reactive silicone (e.g., “SILAPLANE” manufactured by Chisso Corporation) and polysiloxane having a silanol group on each end (JP-A-11-258403).

At least either of the cross-linking reaction and the polymerization reaction of the fluorine-containing polymer and the siloxane polymer having a cross-linkable or a polymerizable group is preferably conducted by irradiation with light or by heating simultaneously with or after coating of the coating composition for forming the outermost layer containing a polymerization initiator and a sensitizing agent to thereby form the low-refractive-index layer.

A sol/gel cured film obtained by conducting condensation reaction between an organometallic compound such as a silane coupling agent and a silane coupling agent having a specific fluorine-containing hydrocarbon group in the copresence of a catalyst to cure is also preferred. For example, there are illustrated a polyfluoroalkyl group-having silane compound or a partially hydrolyzed product thereof (JP-A-58-142958, JP-A-58-147483, JP-A-58-147484, JP-A-59-157582 and JP-A-11-106704), and a silyl compound having a poly(perfluoroalkyl ether) group which is a fluorine-containing long-chain group (JP-A-2000-117902, JP-A-2001-48590 and JP-A-2002-53804).

In addition to the above-described additives, the low-refractive-index layer can contain a filler {e.g., a low-refractive inorganic compound having a primary particle size of from 1 to 150 nm such as silicon dioxide (silica) and fluorine-containing particles (e.g., magnesium fluoride, calcium fluoride and barium fluoride) and organic fine particles described in JP-A-11-3820, paragraphs [0020] to [0038]}, a silane coupling agent, a sliding agent and a surfactant.

In the case where the low-refractive-index layer is positioned under the outermost layer, the low-refractive-index layer may be formed by a gas-phase method (e.g., a vacuum deposition method, a sputtering method, an ion plating method or a plasma CVD method). A coating method is preferred in the point of its low production cost.

The thickness of the low-refractive-index layer is preferably from 30 to 200 nm, more preferably from 50 to 150 nm, most preferably from 60 to 120 nm.

### (Hard Coat Layer)

The hard coat layer is provided on the surface of the protective film in order to impart physical strength to the protective film having provided thereon the anti-reflection layer. It is particularly preferred to provide the hard coat layer between the transparent support and the high-refractive-index layer. The hard coat layer is preferably formed by cross-linking reaction or polymerization reaction of a photo-curable and/or heat-curable compound. As the curable functional group in the curable compound, a photo-polymerizable functional group is preferred. Also, an organometallic compound or organic alkoxysilyl compound having a hydrolyzable functional group is also preferred.

As specific examples of these compounds, there are illustrated the same ones as have been illustrated with respect to the high-refractive-index layer.

As a specific composition for constituting the hard coat layer, there are illustrated those which are described in JP-A-2002-144913, JP-A-2000-9908 and WO00/46617 pamphlet.

The high-refractive-index layer can also function as the hard coat layer. In such cases, the layer is preferably formed by incorporating fine particles in the hard coat layer in a finely dispersed state by employing the technique described with respect to the high-refractive-index layer.

The thickness of the hard coat layer can properly be designed according to use. The thickness of the hard coat layer is preferably from 0.2 to 10 μm, more preferably from 0.5 to 7 μm.

The surface strength of the hard coat layer is preferably H or more, more preferably 2H or more, most preferably 3H or more, in the pencil hardness test according to JIS K-5400. Also, as to an abrasion amount of a test piece after Taber test according to JIS K-5400, the smaller, the more preferred.

### (Other Layers of Anti-Reflection Layer)

Further, a forward scattering layer, a primer layer, an antistatic layer, an undercoat layer and a protective layer may be provided.

### (Antistatic Layer)

In the case of providing an antistatic layer, it is preferred to impart a conductivity of 10⁻⁸ (Ωcm⁻³) or less in volume resistivity. It is possible to impart a volume resistivity of 10⁻⁸ (Ωcm⁻³) by using a hygroscopic substance, a water-soluble inorganic salt, a certain kind of a surfactant, a cation polymer, an anion polymer or colloidal silica. However, there is involved a problem that the conductivity has a large dependence upon temperature and humidity and that a sufficient conductivity can not be obtained at a low humidity. Therefore, a metal oxide is preferred as a material for the conductive layer. Some metal oxides are colored, and use of such metal oxide as a material for the conductive layer causes coloration of the whole film, thus not being preferred. As metals forming a colorless metal oxide, there are illustrated Zn, Ti, Sn, Al, In, Si, Mg, Ba, Mo, W and V. Use of metal oxides containing them as a major component is preferred.

As specific examples of the metal oxides, ZnO, TiO₂, SnO₂, Al₂O₃, In₂O₃, SiO₂, MgO, BaO, MoO₃, WO₃, V₂O₅ and the composite oxides thereof are preferred, with ZnO, TiO₂ and SnO₂ being particularly preferred. As examples containing foreign atoms, addition of Al and In to ZnO, addition of Sb, Nb and halogen element to SnO₂, and addition of Nb and Ta to TiO₂ are effective.

Further, as is described in JP-B-59-6235, materials obtained by depositing the metal oxide onto other crystalline metal particles or fibrous materials (e.g., titanium oxide) may be used. Additionally, volume resistivity and surface resistivity are different physical properties and can not simply be compared with each other. However, in order to ensure a conductivity of 10⁻⁸ (Ωcm⁻³) or less in volume resistivity, it suffices for the antistatic layer to have a surface resistivity of about 10⁻¹⁰ (Ω/□), more preferably 10⁻⁸ (Ω/□) or less. The surface resistivity of the antistatic layer must be measured when the layer constitutes the outermost layer, and can be measured at a stage in the course of forming the laminate film.

### (Liquid Crystal Display Device)

The liquid crystal display device of the invention includes a liquid crystal display device having at least one polarizing plate of the invention (first embodiment), a VA-mode, OCB-mode or TN-mode liquid crystal display device wherein any of the polarizing plate of the invention is used on each of the upper side and the lower side of a cell (second embodiment), and a VA-mode liquid crystal display device wherein any one of the polarizing plates of the invention is used only on the back light side (third embodiment). FIG. 2 is a diagram showing the second embodiment, and the third embodiment corresponds to a case where the polarizing plate of the invention is only used on a light source side in FIG. 2.

That is, the cellulose acylate film of the invention is advantagenously used as an optical compensatory sheet. Also, the polarizing plate: using the cellulose acylate film of the invention is advantageously used for a liquid crystal display device. The polarizing plate of the invention can be applied to liquid crystal cells of various display modes. There have been proposed various display modes such as TN (Twisted Nematic), IPS (In-Plane Switching), FLC (Ferroelectric Liquid Crystal), AFLC (Ant-Ferroelectric Liquid Crystal), OCB (Optically Compensatory Bend), STN (Super Twisted Nematic), VA (Vertically Aligned) and HAN (Hybrid Aligned Nematic). Of these, VA mode and OCB mode are particularly adapted for the use of the polarizing plates.

In the VA mode liquid crystal cell, rod-shaped liquid crystal molecules are aligned substantially vertically upon no voltage being applied thereto.

The VA mode liquid crystal cell includes (1) a VA mode liquid crystal cell in the narrow sense wherein rod-shaped liquid crystalline molecules are aligned substantially vertically while no voltage being applied thereto and are aligned substantially horizontally while a voltage being applied thereto (JP-A-2-176625) and, in addition, (2) a liquid crystal cell (of MVA mode) wherein the VA mode is modified to be multi-domain so as to enlarge the viewing angle {described in SID97, Digest of tech. Papers, 28 (1997), p. 845}, (3) a liquid crystal cell (of n-ASM mode or CPA mode) wherein rod-like liquid crystalline molecules are aligned substantially vertically while no voltage being applied thereto, and the molecules are oriented in twisted multi-domain alignment while a voltage being applied thereto {described in Abstracts of Japanese Forum of Liquid Crystal (written in Japanese), (1998), pp. 58 to 59 and (4) a liquid crystal cell of SURVAIVAL mode (presented at LCD International 98).

As the VA mode liquid crystal display device, there is illustrated a device which comprises a liquid crystal cell (VA mode cell) and two polarizing plates each provided on each side thereof {polarizing plates having TAC1, a polarizer and TAC2) as shown in FIG. 3. The liquid crystal cell has a liquid crystal supported between two electrode substrates, though not particularly shown.

In one embodiment of the transmission type liquid crystal display device of the invention, the cellulose acylate film of the invention is used as an optical compensatory sheet. One sheet thereof is disposed between the liquid crystal cell and one polarizing plate, or two sheets thereof are disposed between the liquid crystal cell and each of the polarizing plates. In the case of disposing one optical compensatory sheet, one of TAC1s shown in FIG. 3 may be replaced by a commercially available cellulose acylate film.

In another embodiment of a transmission type liquid crystal display device of the invention, the cellulose acylate film of the invention is used as a protective film in the polarizing plate to be disposed between a liquid crystal cell and a polarizer. The above-described cellulose acylate film may be used only as a protective film in one polarizing plate (between a liquid crystal cell and a polarizer) or may be used as two protective films in both polarizing plates (between a liquid crystal cell and a polarizer). Lamination onto the liquid crystal cell is preferably performed with the cellulose acylate film of the invention (TAC1) being on the VA cell side. In the case of using the above-described cellulose acylate film only as a protective film in one polarizing plate (between a liquid crystal cell and a polarizer), the polarizing plate may be the upper polarizing plate (on the viewer's side) or the lower polarizing plate (on the back light side), with both causing no functional problems. However, when the polarizer is used as an upper polarizing plate, it becomes necessary to provide a functional film on the viewer's side (upper side), which might reduce productivity. Hence, the polarizing plate is considered to be used more often as a lower polarizing plate, thus being a more preferred embodiment.

A second embodiment of the liquid crystal display device is that wherein the polarizing plate of the invention is used to form both a polarizing plate on the light source side and a polarizing plate on viewer's side as shown in FIG. 3.

The protective film (TAC2) in FIG. 3 may be a commercially available cellulose acylate film and is preferably thinner than the cellulose acylate film of the invention. For example, it has a thickness of preferably from 40 to 80 μm. Examples thereof include commercially available KC4UX2M (manufactured by Konica Opto, Inc.; 40 μm), KC4UX2M (manufactured by Konica Opto, Inc.; 60 μm) and TD80UL (manufactured by Fuji Photo Film Co., Ltd.; 80 μm) which, however, are not limitative at all.

### EXAMPLES

The invention will be described specifically based on Examples which, however, do not limit the invention in any way.

### Example 1

### Formation of a Cellulose Acylate Film Using a Band Casting Machine (Films 1 to 7)

### (1) Cellulose Acylate

Cellulose acylates having different kinds of acyl groups and different substitution degrees as shown in Table I were prepared. Acylation reaction was conducted by adding sulfuric acid (7.8 parts by mass per 100 parts by mass of cellulose) as a catalyst and carboxylic acids as a raw material for the acyl substituent and performing the reaction at 40° C. In this occasion, the kind and substitution degree of the acyl group were controlled by adjusting the kind and amount of the carboxylic acid. After the acylation, ripening was conducted at 40° C. Further, a low molecular component of the cellulose acylate was removed by washing with acetone. Additionally, in the table, CAB is an abbreviation for cellulose acetate butyrate (cellulose ester derivative wherein the acyl group comprises an acetyl group and a butyryl group), CAP is an abbreviation for cellulose acetate propionate (cellulose ester derivative wherein the acyl group comprises an acetyl group and a propionyl group), and CTA means cellulose triacetate (cellulose ester derivative wherein the acyl group comprises only an acetyl group).

### (2) Dissolution

A cellulose acylate described in Table 1, a plasticizer (TPP: triphenyl phosphate; BDP: biphenyl phosphate), a UV ray absorbent (UV1: 2-(2′-hydroxy-3′,5′-di-tert-butylphenyl)benzotriazole; UV2: 2-(2′-hydroxy-3′,5′-di-amylphenyl)-5-chlorobenzotriazole), the following retardation increasing agent (RP1), and the following retardation increasing agent (RP2) were added, under stirring, to a mixed solvent of dichloromethane/methanol (87/13 by mass) so that the concentration of cellulose acylate became 15% by mass, followed by heating under stirring to dissolve. In this occasion, 0.05 part by mass of fine particles of a matt agent (AEROSIL R972; manufactured by Nippon Aerosil Co., Ltd.) and 0.0009 part by mass of a dye (Dye 1) were simultaneously added thereto per 100 parts by mass of cellulose acylate, followed by heating under stirring. The addition amounts in Table 1 are parts by mass per 100 parts by mass of cellulose acylate.

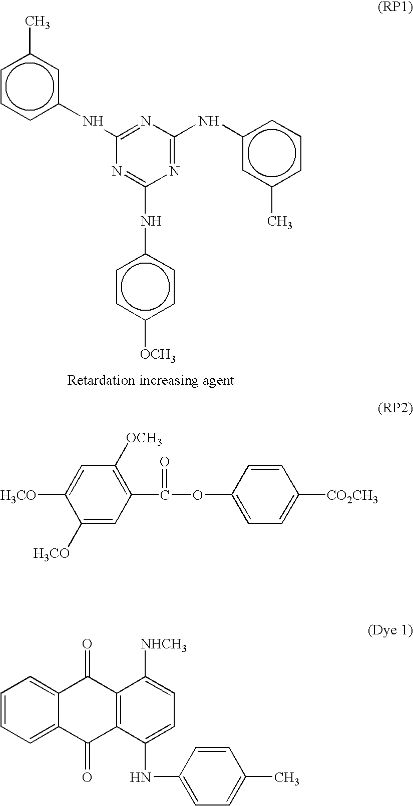

### Casting

Each dope described above was cast using a band casting machine. Each film peeled from the band with a residual solvent amount of from 25 to 35% by mass was stretched at a stretching temperature in a range of from Tg to Tg+10° C. in the longitudinal direction at a stretching ratio of from 0.5 to 5% (see Table 1) in the section after peeling and before a tenter and then in the transverse direction at a stretching ratio of from 0% to 30% (see Table 1) using the tenter and, immediately after the transverse stretching, the film was shrinked at a shrinking ratio of from 0 to 10% in the transverse direction and released from the tenter to thereby form a cellulose acylate film. The stretching ratios are shown in Table 1. With the thus-prepared cellulose acylate films (optical compensatory sheets), Re retardation values and Rth retardation values at wavelengths of 480 nm, 550 nm, 590 nm and 630 nm were measured at 25° C. and 60% RH using KOBRA 21ADH (Ohji Measurement Co., Ltd.). The results thus obtained are shown in Table 1. With the films of the invention, Rth(λ) was calculated taking the average refractive index as 1.48.

With all films obtained in this Example, the haze was from 0.1 to 0.9, the average particle size of secondary particles of the matt agent was 1.0 μm or less, and change in mass after being allowed to stand for 48 hours at 80° C. and 90% RH was from 0 to 3% by mass. Also, dimensional change after being allowed to stand for 24 hours at 60° C. and 95% RH or at 90° C. and 5% RH was from 0 to 4.5%. Further, every sample had a photoelasticity coefficient of 50×10⁻¹³ cm²/dyne (5×10⁻¹¹ m²/N) or less.

### Example 2

### Preparation of Protective Film of 2-Layer Constitution (Film 8)

A polyimide synthesized from 2,2′-bis(3,4-dicarboxyphenyl)hexafluoropropane and 2,2′-bis(trifluoromethyl)-4,4′-diaminobiphenyl was dissolved in cyclohexanone, to thereby prepare a 15% by mass solution. The thus-prepared polyimide solution was applied on “FUJI TAC TD80UL” (manufactured by Fuji Photo Film Co., Ltd.) as a base film such that a film thickness after dried came to be 3.5 μm, dried for 5 minutes at 150° C., stretched by 13% in a width direction by using a tenter stretching machine in an atmosphere of 150° C., relaxed by 2% in the width direction, clipped off of both ends before a roll-up portion, allowed to be a roll film having a width of 1474 mm and a length of 3800 m and, then, rolled up, to thereby obtain a film 8. Thickness of the film 8 was 75 μm. An Re retardation value and an Rth retardation value of the film 8 were measured by using KOBRA 21ADH (manufactured Oji Scientific Instruments) at wavelengths of 480 nm, 550 nm, 590 nm and 630 nm at 25° C. 60% RH. The obtained results are shown in Table 1. The Rth_{(λ)} was calculated as defining an average index of refraction of the film according to the present invention to be 1.58. Haze of the film obtained in the present Example was 1.5.

### Example 3

### Preparation of Protective Film Containing Cyclic Polyolefin (Film 9)

### <Preparation of Cyclic Polyolefin Polymer P-1>

100 parts by mass of purified toluene and 100 parts by mass of methyl norbornene carboxylate were put in a reaction kettle. Next, 25 mmol % (against mass of monomer) of ethyl hexanoate-Ni dissolved in toluene, 0.225 mol % (against mass of monomer) of tri(pentafluorophenyl)boron, and 0.25 mol % (against mass of monomer) of triethyl aluminum were put in the reaction kettle and, then, allowed to react for 18 hours while stirring at room temperature. After termination of such reaction, the resultant reaction mixture was put in an excess amount of ethanol, to thereby generate a polymer deposit. The deposit was purified and the resultant polymer (P-1) was vacuum-dried for 24 hours at 65° C.

A composition described below was put in a mixing tank and mixed, to thereby dissolve individual components therein. The resultant solution was filtered by using a paper filter having an average pore diameter of 34 μm and a sintered metal filter having an average pore diameter of 10 μm.

Cyclic polyolefin solution D-1

| | |
|---|---|
| Cyclic polyolefin P-1 | 150 parts by mass |
| Dichloromethane | 380 parts by mass |
| Methanol | 70 parts by mass |

Next, a composition described below containing the thus-produced cyclic polyolefin solution was put in a dispersing machine, to thereby prepare a fine particle dispersion.

Fine particle dispersion M-1

| | |
|---|---|
| Silica particle having an average particle diameter | 2 parts by mass |
| of 16 nm (Aerosil R972; available from | |
| Nippon Aerosil Co., Ltd.) | |
| Dichloromethane | 73 parts by mass |
| Methanol | 10 parts by mass |
| Cyclic polyolefin solution D-1 | 10 parts by mass |

100 parts by mass of the above-described cyclic polyolefin solution D-1, and 1.35 part by mass of fine particle dispersion M-1 were mixed with each other, to prepare a film-making dope.

The thus-prepared film-making dope was cast by using a band-casting machine. Then, a hot wind was blown from a surface of a web on a metal support. A temperature of the hot wind was 140° C. and a volume of the hot wind was 200 m³/min. When a film had a residual solvent amount of 43% by mass, it was peeled off from a band, stretched in a width direction with a stretching ratio of 10% at a stretching temperature of 140° C. by using a tenter and, then, relaxed in a width direction by 2%, to thereby make a cyclic polyolefin film. Before a rolling-up portion, both ends thereof were clipped off, to thereby obtain a film having a width of 2000 mm and a length of 4000 m. The thus-obtained film was, then, rolled up as a roll film 9.

An Re retardation value and an Rth retardation value of the film 9 were measured by using KOBRA 21ADH (manufactured Oji Scientific Instruments) at wavelengths of 480 nm, 550 nm, 590 nm and 630 nm at 25° C. 60% RH. The obtained results are shown in Table 1. The Rth_{(λ)} was calculated as defining an average index of refraction of the film according to the present invention to be 1.51. Haze of the film obtained in the present Example was 0.5.

### Example 4

### Preparation of Protective Film Containing Cyclic Polyolefin (Film 10)

A composition described below was put in a mixing tank and mixed, to thereby dissolve individual components therein. The resultant solution was filtered by using a paper filter having an average pore diameter of 34 μm and a sintered metal filter having an average pore diameter of 10 μm.

Cyclic polyolefin solution D-2

| | |
|---|---|
| Cyclic polyolefin: Appear 3000 | 100 parts by mass |
| (produced by Promerus LLC) | |
| Dichloromethane | 380 parts by mass |
| Methanol | 70 parts by mass |

Next, a composition described below containing the thus-produced cyclic polyolefin solution was put in a dispersing machine, to thereby prepare a fine particle dispersion M-2.

Fine particle dispersion M-2

| | |
|---|---|
| Silica particle having an average particle diameter | 2 parts by mass |
| of 16 nm (Aerosil R972; available from | |
| Nippon Aerosil Co., Ltd.) | |
| Dichloromethane | 73 parts by mass |
| Methanol | 10 parts by mass |
| Cyclic polyolefin solution D-2 | 10 parts by mass |

100 parts by mass of the above-described cyclic polyolefin solution D-2, and 1.35 part by mass of fine particle dispersion M-2 were mixed with each other, to prepare a film-making dope.

The thus-prepared film-making dope was cast by using a band-casting machine. Then, a hot wind was blown from a surface of a web on a metal support. A temperature of the hot wind was 140° C. and a volume of the hot wind was 200 m³/min. When a film had a residual solvent amount of 38% by mass, it was peeled off from a band, stretched in a width direction with a stretching ratio of 15% at a stretching temperature of 140° C. by using a tenter and, then, relaxed in a width direction by 2%, to thereby make a cyclic polyolefin film. Before a rolling-up portion, both ends thereof were clipped off, to thereby obtain a film having a width of 2000 mm and a length of 4000 m. The thus-obtained film was, then, rolled up as a roll film 10.

An Re retardation value and an Rth retardation value of the film 10 were: measured by using KOBRA 21ADH (manufactured Oji Scientific Instruments) at wavelengths of 480 nm, 550 nm, 590 nm and 630 nm at 25° C. 60% RH. The obtained results are shown in Table 1. The Rth_{(λ)} was calculated as defining an average index of refraction of the film according to the present invention to be 1.51. Haze of the film obtained in the present Example was 0.6.

### Example 5

### Preparation of Protective Film (Protective Film 1) Having Anti-Reflecting Function

### (Preparation of a Coating Solution for a Light-Scattering Layer)

50 g of a mixture of pentaerythritol triacrylate and pentaerythritol tetraacrylate (PETA; manufactured by Nippon Kayaku) was diluted with 38.5 g of toluene. Further, 2 g of a polymerization initiator (Irgacure 184; manufactured by Ciba Specialty Chemicals) was added thereto, and the mixture was stirred. A coat film obtained by coating this solution and curing by UV rays had a refractive index of 1.51.

Further, to this solution were added 1.7 g of a 30% toluene dispersion of cross-linked polystyrene particles (refractive index: 1.60; SX-350; manufactured by Soken Kagaku K.K.) of 3.5 μm in average particle size and 13.3 g of a 30% toluene dispersion of cross-linked acryl-styrene particles (refractive index: 1.55; manufactured by Soken Kagaku K.K.) of 3.5 μm in average particle size, having been dispersed for 20 minutes in a polytron dispersing machine at 10,000 rpm. Finally, 0.75 g of a fluorine-containing surface modifier (FP-1) and 10 g of a silane coupling agent (KBM-5103; manufactured by Shin-Etsu Chemical Co., Ltd.) were added thereto to prepare a complete solution.

The above-described mixed solution was filtered through a polypropylene-made filter of 30 μm in pore size to prepare a coating solution for forming a light-scattering layer.

### <Fluorine-Containing Surface-Improving Agent (FP-1)>

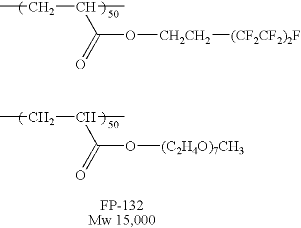

### [Preparation of a Coating Solution for Forming a Low-Refractive-Index Layer]

First, a sol solution a was prepared in the following manner. To a reaction vessel equipped with a stirrer and a reflux condenser were added 120 parts of methyl ethyl ketone, 100 parts of acryloyloxypropyltrimethoxysilane (KBM5103; manufactured by Shin-Etsu Chemical Co., Ltd.) and 3 parts of diisopropoxyaluminum ethyl acetoacetate and, after mixing, 30 parts of deionized water was added, followed by reacting at 60° C. for 4 hours. The reaction mixture was then cooled to room temperature to obtain a sol solution a. The mass-average molecular mass was 1600 and, of the oligomer components and components having a larger molecular mass, components of 1,000 to 20,000 in molecular mass accounted for 100%. Also, analysis by gas chromatography revealed that absolutely no starting acryloyloxypropyltrimethoxysilane remained.

13 g of a thermally cross-linkable, fluorine-containing polymer (JN-7228; solid content: 6%; manufactured by JSR) having a refractive index of 1.42, 1.3 g of silica sol (silica; same as MEK-ST except for particle size; average particle size: 45 nm; solid content: 30%; manufactured by Nissan Kagaku K.K.), 0.6 g of the above-described sol solution a, 5 g of methyl ethyl ketone and 0.6 g of cyclohexanone were mixed and, after stirring, filtered through a polypropylene-made filter of 1 μm in pore size to thereby prepare a coating solution for forming a low-refractive-index layer.

### (Preparation of a Transparent Protective Film Having an Anti-Reflection Layer)

A 80-μm thick triacetyl cellulose film (FUJI TAC TDY80UL; manufactured by Fuji Photo Film Co., Ltd.) was wound off from a roll, and the coating solution for forming the functional layer (light-scattering layer) was coated thereon under the conditions of 30 rpm in gravure roll rotation number and 30 m/min in conveying speed using a microgravure roll of 50 mm in diameter having a gravure pattern of 180 lines/inch and 40 μm in depth and using a doctor blade. After drying at 60° C. for 150 seconds, the coated layer was cured by irradiating with UV rays with a illuminance of 400 mW/cm² and an irradiation amount of 250 mJ/cm² using a 160 W/cm air-cooled metal halide lamp (manufactured by EYEGRAPHICS Co., Ltd.) while purging with nitrogen. Thus, a 6-μm thick functional layer was formed and wound up.

The triacetyl cellulose film having provided thereon the functional layer (light-scattering layer) was again wound off, and the above-prepared coating solution for forming a low-refractive-index layer was coated on the light-scattering layer-coated side of the film under the conditions of 30 rpm in gravure roll rotation number and 15 m/min in conveying speed using a microgravure roll of 50 mm in diameter having a gravure pattern of 180 lines/inch and 40 μm in depth and using a doctor blade. After drying at 120° C. for 150 seconds then at 140° C. for 8 minutes, the coated layer was cured by irradiating with UV rays with a illuminance of 400 mW/cm² and an irradiation amount of 900 mJ/cm² using a 240 W/cm air-cooled metal halide lamp (manufactured by EYEGRAPHICS Co., Ltd.) while purging with nitrogen. Thus, a 100-nmm thick low-refractive-index layer was formed and wound up to prepare a protective film having an anti-reflection layer (protective film 1).

### Example 6

### Preparation of a Polarizing Plate

A 80-μm thick polyvinyl alcohol (PVA) film was dipped in a 2% by mass aqueous solution of potassium iodide at 30° C. for 60 seconds to dye, then longitudinally stretched 5 times as long as the original length while dipping in a 4% by mass aqueous solution of boric acid for 60 seconds, followed by drying at 50° C. for 4 minutes to thereby obtain a 20-μm thick polarizing film A.

Also, a 80-μm thick polyvinyl alcohol (PVA) film was dipped in a 12% by mass aqueous solution of potassium iodide at 30° C. for 60 seconds to dye, then longitudinally stretched 5 times as long as the original length while dipping in a 4% by mass aqueous solution of boric acid for 60 seconds, followed by drying at 50° C. for 4 minutes to thereby obtain a 20-μm thick polarizing film B.

The protective films prepared in Examples 1 and 2 and shown in Table 1 and a commercially available cellulose acylate film of Fuji TAC TDY80UL (manufactured by Fuji Photo Film Co., Ltd.) were dipped in a 1.5 mol/liter, 55° C. sodium hydroxide aqueous solution, then well washed with water to wash away sodium hydroxide. Thereafter, they were dipped in a 0.005 mol/liter, 35° C. dilute sulfuric acid aqueous solution for 1 minute, then dipped in water to sufficiently wash away the dilute sulfuric acid aqueous solution. Finally, each sample was sufficiently dried at 120° C.

The polarizing films were adhesively sandwiched between a combination of the protective films thus subjected to the saponification treatment and prepared in Examples 1 to 3 and the commercially available cellulose acylate Fuji TAC TDY80UL as shown in Table 2 using a polyvinyl alcohol type adhesive, to thereby obtain polarizing plates 1 to 11.

On one side of the polarizer prepared in a same manner as in Example 1, the commercially available cellulose acylate film Fuji TAC TDY80UL (manufactured by Fuji Photo Film Co., Ltd.) was stuck by using a polyvinyl alcohol type adhesive and, one the other side thereof, the films 9 and 10 prepared in Examples 3 and 4, respectively, were stuck by using an acrylic adhesive DD624 (manufactured by Nogawa Chemical Co., Ltd.), to thereby obtain polarizing plates 12 and 13, respectively.

In this occasion, the polarizing film and the protective film to be stuck on each side of the polarizing film are prepared in a roll form, and hence the longitudinal directions of the roll films are parallel to each other, thus being continuously laminated one over the other. Also, as is shown in FIG. 1, with the protective film disposed on the cell side, the transmission axis of the polarizer is parallel to the slow axis of the optical compensatory sheets prepared in Example 1 to 4.

To the cell-side surface of the above-prepared polarizing plate was applied an acrylic adhesive and, further, a separate film was stuck onto the adhesive layer. A protect film was stuck onto the opposite side to the cell side.

### Example 7

The spectral reflectance with an incident angle of 5° was measured from the functional film side in the range of from 380 to 780 nm using a spectrophotometer (manufactured by Nihon Bunko K.K.). The integrating sphere-average reflectance in the range of from 450 to 650 nm was determined to be 2.3% with the polarizing plates 9 and 10 using the protective film 1 which is a transparent protective film having an anti-reflection layer. Here, the reflectance was measured after peeling the protect film on the transparent protective film having the anti-reflection layer.

TABLE 1

| | | Optical Compensatory sheet | | | | |
|---|---|---|---|---|---|---|
| | | Film 1 | Film 2 | Film 3 | Film 4 | Film 5 |
| Cellulose | Kind of | CTA | CTA | CTA | CAP | CAB |
| Acylate | Cellulose | | | | | |
| | Acylate | | | | | |
| | Substituent A | Ac | Ac | Ac | Ac | Ac |
| | Substitution | 2.81 | 2.81 | 2.87 | 1.9 | 1.1 |
| | Degree of A | | | | | |
| | Substituent B | — | — | — | Pr | Bu |
| | Substitution | 0 | 0 | 0 | 0.8 | 1.6 |
| | Degree of B | | | | | |
| | Total | 2.81 | 2.81 | 2.87 | 2.7 | 2.7 |
| | Substitution | | | | | |
| | Degree | | | | | |
| | Substitution | 0.9 | 0.9 | 0.907 | 0.897 | 0.881 |
| | Degree at 6- | | | | | |
| | Position | | | | | |
| | Substitution | 0.320 | 0.320 | 0.316 | 0.332 | 0.326 |
| | Ratio at 6- | | | | | |
| | Position | | | | | |
| Additives | Kinds of | TPP/BDP | TPP/BDP | TPP/BDP | TPP/BDP | TPP/BDP |
| | Plasticizers | | | | | |
| | Amounts of | 7.8/3.9 | 7.8/3.9 | 7.8/3.9 | 7.8/3.9 | 7.8/3.9 |
| | Plasticizers | | | | | |
| | (parts by mass | | | | | |
| | per 100 parts | | | | | |
| | by mass of | | | | | |
| | cellulose | | | | | |
| | acylate) | | | | | |
| | Kinds of | Retardation- | Retardation- | Retardation- | UV1/UV2 | Retardation- |
| | Additives | increasing | increasing | increasing | | increasing |
| | | agent (RP1) | agent | agent (RP1) | | agent |
| | | | (RP1)/Retardation- | | | (RP1) |
| | | | increasing | | | |
| | | | agent (RP2) | | | |
| | Amounts of | 6.4 | 2.6/3.8 | 8 | 0.7/0.3 | 3 |
| | Additives | | | | | |
| | (parts by mass | | | | | |
| | per 100 parts | | | | | |
| | by mass of | | | | | |
| | cellulose | | | | | |
| | acylate) | | | | | |
| Stretching | Longitudinal | 3 | 3 | 5 | 5 | 0.5 |
| Ratio | Stretching | | | | | |
| | Ratio | | | | | |
| | Transverse | 32 | 32 | 34 | 32 | 32 |
| | Stretching | | | | | |
| | Ratio | | | | | |
| | Relaxation | 7 | 7 | 6 | 7 | 7 |
| | Ratio | | | | | |
| Film Thickness | | 85 | 85 | 92 | 110 | 80 |
| Re(λ) | Re(590) nm | 55 | 55 | 50 | 62 | 50 |
| Rth(λ) | Rth(590) nm | 200 | 190 | 195 | 190 | 200 |
| | Re(480)/ | 1.03 | 1.03 | 1.08 | 0.95 | 1.03 |
| | Re(550) | | | | | |
| | Re(630)/ | 0.98 | 0.98 | 0.95 | 1.02 | 0.98 |
| | Re(550) | | | | | |
| | Rth(480)/ | 1.02 | 1.02 | 1.06 | 0.95 | 1.02 |
| | Rth(550) | | | | | |
| | Rth(630)/ | 0.99 | 0.99 | 0.96 | 1.02 | 0.99 |
| | Rth(550) | | | | | |

| | | Polarizing Plate | | | | |
|---|---|---|---|---|---|---|
| | | Polarizing | Polarizing | Polarizing | Polarizing | Polarizing |
| | | Plate 1 | Plate 2 | Plate 3 | Plate 4 | Plate 5 |
| Polarizer | Polarizing Film | A | A | A | A | A |
| | Cross-Nicol | −0.05 | −0.05 | −0.05 | −0.05 | −0.05 |
| | Tint a | | | | | |
| | Cross-Nicol | −0.35 | −0.35 | −0.35 | −0.35 | −0.35 |
| | Tint b | | | | | |
| | Single Plate | 42.8 | 42.8 | 42.8 | 42.8 | 42.8 |
| | Transmittance | | | | | |
| | (%) | | | | | |
| | Parallel | 36.6 | 36.6 | 36.6 | 36.6 | 36.6 |
| | Transmittance | | | | | |
| | (%) | | | | | |
| | Orthogonal | 0.004 | 0.004 | 0.004 | 0.004 | 0.004 |
| | Transmittance | | | | | |
| | (%) | | | | | |
| | Polarizing | 99.98 | 99.98 | 99.98 | 99.98 | 99.98 |
| | Degree (%) | | | | | |

| | | Optical Compensatory Sheet | | | | |
|---|---|---|---|---|---|---|
| | | Film 6 | Film 7 | Film 1 | TDY80UL | TDY80UL |
| Cellulose | Kind of | CTA | CTA | CTA | — | — |
| Acylate | Cellulose | | | | | |
| | Acylate | | | | | |
| | Substituent A | | | Ac | — | — |
| | Substitution | 2.81 | 2.81 | 2.81 | — | — |
| | Degree of A | | | | | |
| | Substituent B | — | — | — | — | — |
| | Substitution | 0 | 0 | 0 | — | — |
| | Degree of B | | | | | |
| | Total | 2.81 | 2.81 | 2.81 | — | — |
| | Substitution | | | | | |
| | Degree | | | | | |
| | Substitution | 0.9 | 0.9 | 0.9 | — | — |
| | Degree at 6- | | | | | |
| | Position | | | | | |
| | Substitution | 0.320 | 0.320 | 0.320 | — | — |
| | Ratio at 6- | | | | | |
| | Position | | | | | |
| Additives | Kinds of | TPP/BDP | TPP/BDP | TPP/BDP | — | — |
| | Plasticizers | | | | | |
| | Amounts of | 7.8/3.9 | 7.8/3.9 | 7.8/3.9 | — | — |
| | Plasticizers | | | | | |
| | (parts by mass | | | | | |
| | per 100 parts | | | | | |
| | by mass of | | | | | |
| | cellulose | | | | | |
| | acylate) | | | | | |
| | Kinds of | Retardation- | Retardation- | Retardation- | — | — |
| | Additives | increasing | increasing | increasing | | |
| | | agent (RP1) | agent (RP1) | agent (RP1) | | |
| | Amounts of | 7 | 5 | 6.4 | — | — |
| | Additives | | | | | |
| | (parts by mass | | | | | |
| | per 100 parts | | | | | |
| | by mass of | | | | | |
| | cellulose | | | | | |
| | acylate) | | | | | |
| Stretching | Longitudinal | 0.5 | 0.5 | 3 | — | — |
| Ratio | Stretching | | | | | |
| | Ratio | | | | | |
| | Transverse | 32 | 27 | 32 | — | — |
| | Stretching | | | | | |
| | Ratio | | | | | |
| | Relaxation | 7 | 7 | 7 | — | — |
| | Ratio | | | | | |
| Film Thickness | | 92 | 88 | 85 | 80 | 80 |
| Re(λ) | Re(590) nm | 70 | 40 | 55 | 3 | 3 |
| Rth(λ) | Rth(590) nm | 220 | 190 | 200 | 45 | 45 |
| | Re(480)/ | 1.05 | 1.03 | 1.03 | −1 | −1 |
| | Re(550) | | | | | |
| | Re(630)/ | 0.97 | 1.00 | 0.98 | 3 | 3 |
| | Re(550) | | | | | |
| | Rth(480)/ | 1.04 | 1.02 | 1.02 | 0.85 | 0.85 |
| | Rth(550) | | | | | |
| | Rth(630)/ | 0.98 | 1.00 | 0.99 | 1.13 | 1.13 |
| | Rth(550) | | | | | |

| | | Polarizing Plate | | | | |
|---|---|---|---|---|---|---|
| | | Polarizing | Polarizing | Polarizing | Polarizing | Polarizing |
| | | Plate 6 | Plate 7 | Plate 8 | Plate 9 | Plate 10 |
| Polarizer | Polarizing Film | A | A | B | A | B |
| | Cross-Nicol | −0.05 | −0.05 | 0.1 | −0.05 | 0.1 |
| | Tint a | | | | | |
| | Cross-Nicol | −0.35 | −0.35 | −3.0 | −0.35 | −3.0 |
| | Tint b | | | | | |
| | Single Plate | 42.8 | 42.8 | 43.2 | 42.8 | 43.2 |
| | Transmittance | | | | | |
| | (%) | | | | | |
| | Parallel | 36.6 | 36.6 | 37.1 | 36.6 | 37.1 |
| | Transmittance | | | | | |
| | (%) | | | | | |
| | Orthogonal | 0.004 | 0.004 | 0.006 | 0.004 | 0.006 |
| | Transmittance | | | | | |
| | (%) | | | | | |
| | Polarizing | 99.98 | 99.98 | 99.97 | 99.98 | 99.97 |
| | Degree (%) | | | | | |

| | | Optical Compensatory | | |
|---|---|---|---|---|
| | | Sheet | | |
| | | Film 8 | Film 9 | Film 10 |
| Cellulose | Kind of | — | — | — |
| Acylate | Cellulose | | | |
| | Acylate | | | |
| | Substituent A | — | — | — |
| | Substitution | — | — | — |
| | Degree of A | | | |
| | Substituent B | — | — | — |
| | Substitution | — | — | — |
| | Degree of B | | | |
| | Total | — | — | — |
| | Substitution | | | |
| | Degree | | | |
| | Substitution | — | — | — |
| | Degree at 6- | | | |
| | Position | | | |
| | Substitution | — | — | — |
| | Ratio at 6- | | | |
| | Position | | | |
| Additives | Kinds of | — | — | — |
| | Plasticizers | | | |
| | Amounts of | — | — | — |
| | Plasticizers | | | |
| | (parts by mass | | | |
| | per 100 parts | | | |
| | by mass of | | | |
| | cellulose | | | |
| | acylate) | | | |
| | Kinds of | — | — | — |
| | Additives | | | |
| | Amounts of | — | — | — |
| | Additives | | | |
| | (parts by mass | | | |
| | per 100 parts | | | |
| | by mass of | | | |
| | cellulose | | | |
| | acylate) | | | |
| Stretching | Longitudinal | 0 | 0 | 0 |
| Ratio | Stretching | | | |
| | Ratio | | | |
| | Transverse | 13 | 10 | 15 |
| | Stretching | | | |
| | Ratio | | | |
| | Relaxation | 2 | 2 | 2 |
| | Ratio | | | |
| Film Thickness | | 75 | 75 | 80 |
| Re(λ) | Re(590) nm | 54 | 58 | 56 |
| Rth(λ) | Rth(590) nm | 210 | 220 | 210 |
| | Re(480)/ | 1.04 | 1.01 | 1.01 |
| | Re(550) | | | |
| | Re(630)/ | 0.97 | 0.99 | 0.99 |
| | Re(550) | | | |
| | Rth(480)/ | 1.03 | 1.01 | 1.01 |
| | Rth(550) | | | |
| | Rth(630)/ | 0.98 | 0.99 | 0.99 |
| | Rth(550) | | | |

| | | Polarizing Plate | | |
|---|---|---|---|---|
| | | Polarizing | Polarizing | Polarizing |
| | | Plate 11 | Plate 12 | Plate 13 |
| Polarizer | Polarizing Film | A | A | A |
| | Cross-Nicol | −0.05 | −0.05 | −0.05 |
| | Tint a | | | |
| | Cross-Nicol | −0.35 | −0.35 | −0.35 |
| | Tint b | | | |
| | Single Plate | 42.8 | 42.8 | 42.8 |
| | Transmittance | | | |
| | (%) | | | |
| | Parallel | 36.6 | 36.6 | 36.6 |
| | Transmittance | | | |
| | (%) | | | |
| | Orthogonal | 0.004 | 0.004 | 0.004 |
| | Transmittance | | | |
| | (%) | | | |
| | Polarizing | 99.98 | 99.98 | 99.98 |
| | Degree (%) | | | |

TABLE 2

| | | | Opposite Side |
|---|---|---|---|
| Polarizing Plate | Cell Side | Polarizing Film | to Cell Side |
| Polarizing Plate 1 | Film 1 | A | TDY80UL |
| Polarizing Plate 2 | Film 2 | A | TDY80UL |
| Polarizing Plate 3 | Film 3 | A | TDY80UL |
| Polarizing Plate 4 | Film 4 | A | TDY80UL |
| Polarizing Plate 5 | Film 5 | A | TDY80UL |
| Polarizing Plate 6 | Film 6 | A | TDY80UL |
| Polarizing Plate 6 | Film 6 | A | TDY80UL |
| Polarizing Plate 7 | Film 7 | A | TDY80UL |
| Polarizing Plate 8 | Film 1 | B | TDY80UL |
| Polarizing Plate 9 | Protective Film 1 | A | TDY80UL |
| Polarizing Plate 10 | Protective Film 1 | B | TDY80UL |
| Polarizing Plate 11 | Film 8 | A | TDY80UL |
| Polarizing Plate 12 | Film 9 | A | TDY80UL |
| Polarizing Plate 13 | Film 10 | A | TDY80UL |

### Example 8

A polarizing plate and a retardation plate disposed on the surface side and on the back side of a VA mode liquid crystal TV set (LC-32AD5; manufactured by Sharp Corp.) were peeled, and the polarizing plates 1 to 13 prepared in Example 3 were stuck thereto with a combination shown in Table 3. In this occasion, the polarizing plates were disposed so that the absorption axis of a polarizing plate on the viewer's side was in the horizontal direction of the panel, and the absorption axis of a polarizing plate on the backlight side was in the vertical direction of the panel, with the adhesive surface facing the liquid cell side. Also, a cold cathode ray tube in the liquid crystal display device LCD7 as a backlight was replaced by a backlight of 12000K in color temperature.

After peeling the protect film, luminance and chromaticity upon black display and upon white display were measured in a dark room using a measuring machine (EZ-Contrast 160D; manufactured by ELDIM), and color shift and contrast ratio were calculated based on the obtained data. The results are shown in Table 3. The color shift and the viewing angle upon black display are described below. Additionally, chromaticity is a value of the coordinate of x-y chromaticity space of CIE.

### [Black Color Shift in the Polar Angle Direction]

Changes in chromaticity, Δxθ and Δyθ, in the case where the viewing angle is inclined from the normal direction of the liquid crystal cell to the center line direction of the transmission axes of a pair of the polarizing plates (azimuthal angle: 45°) upon black display preferably always satisfy the following numerical formulae (XXIII) and (XXIV) between 0 and 80° in polar angle.

0≦Δxθ≦0.1 Numerical formula (XXIII)

0≦Δyθ≦0.1 Numerical formula (XXIV)

In the above formulae, Δxθ=xθ−Δxθ_{O}, Δyθ=yθ−Δyθ_{O}, (xθ_{O}, yθ_{O}) represents chromaticity measured in the normal direction of the liquid crystal cell upon black display, and (xθ, yθ) represents chromaticity measured in the direction inclined from the normal direction of the liquid crystal cell toward the center line direction of a pair of the polarizing plates by θ degrees in polar angle upon black display.

### [Black Color Shift in the Azimuthal Angle Direction]

Changes in chromaticity, Δxφ and Δyφ, in the case where chromaticity is measured by inclining the viewing angle from the normal direction of the liquid crystal cell toward the absorption axis of the polarizing plate on the viewing side by 60° and rotating from this direction by 360° with the normal line being the center preferably always satisfy the following numerical formulae (XXV) and (XXVI) between 0 and 360° in azimuthal angle.

−0.02≦Δxφ≦0.1 Numerical formula (XXV)

−0.02≦Δyφ≦0.1 Numerical formula (XXVI)

In the above formulae, Δxφ=xφ−Δxφ_{O}, Δyφ=yφ−Δyφ_{O}, (xφ_{O}, yφ_{O}) represents chromaticity measured by inclining the viewing angle from the normal direction of the liquid crystal cell giving black display toward the absorption axis of the polarizing plate on the viewing side by 60°, and (xφ, yφ) represents chromaticity measured by inclining the viewing angle from the normal direction of the liquid crystal cell giving black display toward the absorption axis of the polarizing plate on the viewing side by 60° and rotating the inclined viewing angle by φ in azimuthal angle with the normal line direction being the center.

### [Viewing Angle]

A larger contrast ratio at 45° in azimuthal angle and 60° in polar angle means a wider viewing angle.

### [Observation of Black Display Under Illumination]

A liquid crystal display device in a black display state was viewed, under the illumination of a day-light fluorescent lamp, from a direction of 45° in azimuthal angle and 60° in polar angle under the environment of 150 (1×) in irradiance on the surface of a liquid crystal display device to observe brightness of the screen and displayed colors. Results thus obtained are shown in Table 3.

As is shown in Table 3, liquid crystal display devices LCD1 to LCD5 and LCD10 to LCD12 using a polarizing plate satisfying the conditions of the invention with respect to retardation characteristics and hues a^{*} and b^{*} suffered less color shift in the azimuthal angle and in the polar angle direction, gave sufficiently dark black color at black display portions of the device screen even in a bright room and a sufficient viewing angle contrast. On the other hand, among liquid crystal display devices of Comparative Examples, there were no display devices which satisfied all of the above-described characteristics though some display devices satisfied part of the characteristics.

TABLE 3

| | Polarizing Plate on Viewing Side | | | | Backlight Side | | | |
|---|---|---|---|---|---|---|---|---|
| Liquid Crystal | Polarizing | Opposite Side to | Polarizing | | | | Polarizing | Opposite Side to |
| Display Device | Plate | Cell | Film | Cell Side | Polarizing Plate | Cell Side | Film | Cell |
| LCD1 | Polarizing | Protective Film 1 | A | TDY80UL | Polarizing Plate 1 | Film 1 | A | TDY80UL |
| | Plate 9 | | | | | | | |
| LCD2 | Polarizing | Protective Film 1 | A | TDY80UL | Polarizing Plate 2 | Film 2 | A | TDY80UL |
| | Plate 9 | | | | | | | |
| LCD3 | Polarizing | Protective Film 1 | A | TDY80UL | Polarizing Plate 3 | Film 3 | A | TDY80UL |
| | Plate 9 | | | | | | | |
| LCD4 | Polarizing | Protective Film 1 | A | TDY80UL | Polarizing Plate 4 | Film 4 | A | TDY80UL |
| | Plate 9 | | | | | | | |
| LCD5 | Polarizing | Protective Film 1 | A | TDY80UL | Polarizing Plate 5 | Film 5 | A | TDY80UL |
| | Plate 9 | | | | | | | |
| LCD6 | Polarizing | Protective Film 1 | A | TDY80UL | Polarizing Plate 6 | Film 6 | A | TDY80UL |
| | Plate 9 | | | | | | | |
| LCD7 | Polarizing | Protective Film 1 | A | TDY80UL | Polarizing Plate 6 | Film 6 | A | TDY80UL |
| | Plate 9 | | | | | | | |
| LCD8 | Polarizing | Protective Film 1 | A | TDY80UL | Polarizing Plate 7 | Film 7 | A | TDY80UL |
| | Plate 9 | | | | | | | |
| LCD9 | Polarizing | Protective Film 1 | B | TDY80UL | Polarizing Plate 8 | Film 1 | B | TDY80UL |
| | Plate 10 | | | | | | | |
| LCD10 | Polarizing | Protective Film 1 | A | TDY80UL | Polarizing Plate 11 | Film 8 | A | TDY80UL |
| | Plate 9 | | | | | | | |
| LCD11 | Polarizing | Protective Film 1 | A | TDY80UL | Polarizing Plate 12 | Film 9 | A | TDY80UL |
| | Plate 9 | | | | | | | |
| LCD12 | Polarizing | Protective Film 1 | A | TDY80UL | Polarizing Plate 13 | Film 10 | A | TDY80UL |
| | Plate 9 | | | | | | | |

| Liquid | Color | | | | | | Visual | | |
|---|---|---|---|---|---|---|---|---|---|
| Crystal | Temperature | | | | | CR@ | Evaluation | | |
| Display | of Back | Black Color Shift | | | | φ = 45/ | in Bright | CR@ | |
| Device | Light | Δxθ | Δyθ | Δxφ | Δyφ | θ = 60 | Room | φ = 0/θ = 60 | Note |
| LCD1 | 8500 K | 0-0.05 | 0-0.05 | 0-0.04 | 0-0.4 | 40 | black and | 750 | present |
| | | | | | | | dark | | invention |
| LCD2 | 8500 K | 0-0.06 | 0-0.06 | 0-0.05 | 0-0.05 | 36 | black and | 740 | present |
| | | | | | | | dark | | invention |
| LCD3 | 8500 K | 0-0.06 | 0-0.06 | 0-0.05 | 0-0.05 | 36 | black and | 700 | present |
| | | | | | | | dark | | invention |
| LCD4 | 8500 K | 0-0.05 | 0-0.05 | 0-0.05 | 0-0.05 | 38 | black and | 730 | present |
| | | | | | | | dark | | invention |
| LCD5 | 8500 K | 0-0.06 | 0-0.06 | 0-0.05 | 0-0.05 | 38 | black and | 730 | present |
| | | | | | | | dark | | invention |
| LCD6 | 8500 K | −0.02-0.02 | −0.02-0.02 | −0.03-0.02 | −0.03-0.02 | 39 | bluish black | 720 | comparative |
| | | | | | | | and dark | | sample |
| LCD7 | 12000 K | −0.02-0.02 | −0.02-0.02 | −0.03-0.02 | −0.03-0.02 | 39 | bluish black | 710 | comparative |
| | | | | | | | and bright | | sample |
| LCD8 | 8500 K | 0-1.2 | 0-1.2 | 0-1.1 | 0-1.1 | 20 | reddish black | 710 | comparative |
| | | | | | | | and bright | | sample |
| LCD9 | 8500 K | 0-1.3 | 0-1.3 | 0-1.2 | 0-1.2 | 40 | bluish black | 750 | comparative |
| | | | | | | | and bright | | sample |
| LCD10 | 8500 K | 0-0.05 | 0-0.05 | 0-0.04 | 0-0.04 | 40 | black and | 600 | present |
| | | | | | | | dark | | invention |
| LCD11 | 8500 K | 0-0.06 | 0-0.06 | 0-0.05 | 0-0.05 | 55 | black and | 780 | present |
| | | | | | | | dark | | invention |
| LCD12 | 8500 K | 0-0.06 | 0-0.06 | 0-0.05 | 0-0.05 | 50 | black and | 770 | present |
| | | | | | | | dark | | invention |

### INDUSTRIAL APPLICABILITY

The polarizing plate of the invention is excellent in the effect of both enlarging the viewing angle and reducing color shift upon black display.

Also, the liquid crystal display device of the invention can both enlarge the viewing angle and reduce color shift upon black display.

The entire disclosure of each and every foreign patent application from which the benefit of foreign priority has been claimed in the present application is incorporated herein by reference, as if fully set forth.

1. A polarizing plate comprising:
at least one protective film; and
a polarizing film,
wherein the protective film disposed on a liquid crystal cell side has Re_{(λ)} and Rth_{(λ)} satisfying following numerical formulae (I) and (II), and
wherein the polarizing plate gives, when disposed in an orthogonal position, a hue a^{*} and a hue b^{*} of the polarizing plate disposed in an orthogonal position satisfying following numerical formulae (III) and (IV):
45 nm≦Re₍₅₉₀₎≦65 nm numerical formula (I)
150 nm≦Rth₍₅₉₀₎≦240 nm numerical formula (II)
−1.0≦a^{*}≦2.0 numerical formula (III)
−1.0≦b^{*}≦2.0 numerical formula (IV)
wherein Re_{(λ)} represents a retardation value in plane at a wavelength of λnm (unit: nm); and
Rth_{(λ)} represents a retardation value along a thickness of the film (unit: nm).

2. The polarizing plate according to claim 1, which has a single plate transmission of 41% or more, a parallel transmission of 35% or more, an orthogonal transmission of 0.02% or less and a polarizing degree of 99.93% or more.

3. The polarizing plate according to claim 1, wherein the protective film disposed on a liquid crystal cell side has Re_{(λ)} and Rth_{(λ)} satisfying following numerical formulae (V) to (VIII):
1.0≦Re₍₄₈₀₎/Re₍₅₅₀₎≦1.1 numerical formula (V)
0.9≦Re₍₆₃₀₎/Re₍₅₅₀₎≦1.0 numerical formula (VI)
1.0≦Rth₍₄₈₀₎/Rth₍₅₅₀₎≦1.1 numerical formula (VII)
0.9≦Rth₍₆₃₀₎/Rth₍₅₅₀₎≦1.0. numerical formula (VIII)

4. The polarizing plate according to claim 1, wherein the protective film disposed on a liquid crystal side is a cellulose acylate film comprising a cellulose acylate obtained by substituting hydroxyl groups of glucose unit constituting cellulose with an acyl group containing 2 or more carbon atoms, and satisfying following formulae (IX) and (X):
2.0≦DS2+DS3+DS6≦3.0 (IX)
DS6/(DS2+DS3+DS6)≧0.315 (X)
wherein DS2 represents a substitution degree of hydroxyl group at 2-position of the glucose unit by the acyl group;
DS3 represents a substitution degree of hydroxyl group at 3-position of the glucose unit by the acyl group; and
DS6 represents a substitution degree of hydroxyl group at 6-position of the glucose unit by the acyl group.

5. The polarizing plate according to claim 4, wherein the acyl group is an acetyl group.

6. The polarizing plate according to claim 1, wherein the protective film disposed on a liquid crystal side is a cellulose acylate film containing a cellulose acylate, which is a mixed fatty acid ester of cellulose, as a major polymer component, wherein hydroxyl groups of the cellulose are substituted by an acetyl group and an acyl group containing 3 or more carbon atoms, and
wherein a substitution degree A of the acetyl group and a substitution degree B of the acyl group containing 3 or more carbon atoms satisfying following numerical formulae (XI) and (XII):
2.0≦A+B≦3.0 numerical formula (XI)
0<B. numerical formula (XII)

7. The polarizing plate according to claim 6, wherein the acyl group containing 3 or more carbon atoms is a butanoyl group.

8. The polarizing plate according to claim 6, wherein the acyl group containing 3 or more carbon atoms is a propionyl group.

9. The polarizing plate according to claim 6, wherein the substitution degree of the hydroxyl group at 6-position of cellulose is 0.75 or more.

10. The polarizing plate according to claim 1, wherein the protective film disposed on a liquid crystal side is a film comprising a cyclic polyolefin.

11. The polarizing plate according to claim 1, wherein the protective film disposed on a liquid crystal side contains at least one of a plasticizer, a UV ray absorbent, a peeling accelerator, a dye and a matt agent.

12. The polarizing plate according to claim 1, wherein the protective film disposed on a liquid crystal side contain one or more rod-like or discotic compound as a retardation increasing agent.

13. The polarizing plate according to claim 1, wherein the protective film disposed on a liquid crystal side is a film consisting of a single layer.

14. A liquid crystal display device comprising:
a liquid crystal cell; and
a pair of polarizing plates respectively disposed on both sides of the liquid crystal cell in an orthogonal position,
wherein at least one of the pair of the polarizing plates is a polarizing plate according to claim 1.

15. The liquid crystal display device according to claim 14, wherein a color temperature of a back light is between 8,000 and 10,000K.

16. The liquid crystal display device according to claim 14, wherein the liquid crystal cell is of a vertically aligned mode.
